(19) United States
(12) Patent Application Publication
(10) Pub. No.: US 2007/0280296 A1
(43) Pub. Date: Dec. 6, 2007

(54) System and method for measuring distribution quality of video image

(75) Inventors: Kazuya Suzuki, Tokyo (JP); Masahiro Jibiki, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/802,953

(22) Filed: May 29, 2007

(30) Foreign Application Priority Data
May 30, 2006 (JP) 2006-149959

(51) Int. Cl. H04J 1/00

(52) U.S. Cl. 370/485; 370/352

(57) ABSTRACT

A measuring system of distribution quality of a video image includes a distribution server, an receiving terminal, an upstream side reception time data generating section, a downstream side reception time data generating section and a quality data measuring section. The distribution server is provided in a center to transmit packets for a video image through a network, and the receiving terminal is provided in a user home to receive the packets transmitted through the network from the distribution server. The upstream side reception time data generating section is provided in the center to generate an upstream side reception time data indicating a time when the distribution server transmits one of the packets. The downstream side reception time data generating section is provided for the user home to generate a downstream side reception time data indicating a time when the receiving terminal receives the packet. The quality data measuring section is provided for one of the center and the user home, to measure a distribution quality indicating a distribution state from the distribution server to the receiving terminal based on the upstream side reception time data and the downstream side reception time data.

### CROSS REFERENCE

This application is based upon and claims the benefit of priority from Japanese patent application No. 2006-149959, filed on May 30, 2006. Also, this application relates to the U.S. patent application Ser. No. ______, titled “PACKET DISTRIBUTION SYSTEM USING REPRODUCING APPARATUS AND PACKET DISTRIBUTION METHOD” by Kazuya SUZUKI and Masahiro JIBIKI, claiming the priority based on Japanese Patent Application No. 2006-149960 filed on May 30, 2006. The disclosures of these applications are incorporated herein by reference.

### TECHNICAL FIELD

The present invention relates to a system and a method for measuring distribution quality of a video image.

### BACKGROUND ART

A video image distribution service for distributing a video image data through a network has been spread widely. In recent years, a video image distribution service for distributing a video image data in a higher quality than the foregoing video image data has been developed. It is difficult to attain this image distribution service in a conventional narrowband network. However, this has been gradually attained in accompaniment with the spreading of a broadband network. Also, a distribution server distributes a video image data through the network to a receiving terminal serving, and a user can enjoy the video image data by use of the receiving terminal. This video image data is converted into packets, and a multicast technique is used as the distribution of the packets. The multicast technique is used as an alternative of a unicast technique. For example, in the unicast technique, the distribution server distributes a plurality of streams (packets) to a plurality of receiving terminals, respectively. In the multicast technique, the distribution server distributes a single stream to the plurality of receiving terminals. Since the multicast technique is used, the distribution to a large number of users can be attained while the bands for the distribution server and the network are saved.

However, the video image distributing service has the following problems. In the image distribution, there may be a case that a phenomenon that some of packets of the video image data are lost or the packets do not arrive within a predetermined time period. In this case, a severe influence is given on the video image to be reproduced by the receiving terminal. In particular, IP of the protocol of a network layer which is used currently widely has a possibility that a packet loss occurs at a time of convergence, because of its specification. In a typical communication, as the function of a protocol of a transport layer located at the higher order than a network layer, the low reliability of the IP is compensated by performing an arrival check or a retransmission. Even in the video image distribution, a countermeasure against the packet loss can be performed by performing the retransmission. However, until the arrival check is confirmed, the packet is required to be buffered for each distribution destination. In this way, as the load becomes heavy, it is difficult to employ this countermeasure for the distribution to the many users. Also, there is no insurance with regard to a transmission delay. Hence, there is a possibility that a great variation is generated in the transmission delay.

When a problem has occurred in reproduction of a video image, a distribution state (distribution quality) for each distribution destination is required to be checked in order to examine its cause. Here, the distribution quality indicates the state that the packets are distributed from the distribution server to each of the receiving terminals, and this includes the transmission delay for each packet, a jitter, and a discard rate of the packets per certain time period.

A Japanese Laid Open Patent Application (JP-P2004-172748A) indicates a method that monitors the distribution state of the video image. In this method, a stream relaying apparatus monitors the number of the arrived packets per certain time, and when the number of the arrived packets exceeds a predetermined value or the packet does not arrive for a certain time period, the state is judged to be abnormal. In this method, the use band of the video image to be distributed is required to be known in advance, and the number of the arrived packets per certain time period in the normal case is required to be known. Also, the measurements of the transmission delay and the jitter are not considered.

RTP (“RFC3550”, [online], Internet Society, [Retrieval of Apr. 17, 2006], Internet <URL:http://www.ietf.org/rfc/rfc3550.txt>) is applied to the protocol widely used in the video image distribution. A time stamp field that stores a value indicating a time stamp exists in the RTP header of the packet that is applied to this protocol. However, this time stamp indicates a sampling time of a data included in a payload, and this is used to control the timing of the reproduction of the video image in a receiving terminal. For this reason, from the viewpoint of the use to measure the transmission delay and jitter in the network in a strict meaning, the precision is low. Also, the meaning of the value stored in this time stamp field is different for each payload format of the RTP. Thus, in order to use the time stamp field, it is necessary to employ the measuring method that is different for each payload.

In this way, in the foregoing techniques, the processing must be performed on the packet, in order to measure the distribution quality.

Japanese Laid Open Patent Application (JP-P2004-120230A) describes a QoS control method in a data communication. In the QoS control method in the data communication for transmitting data packets from a first node through a network to a second node, a time synchronization is set between the first node and the second node prior to the communication. The first node adds a transmission time of the data packet and a service quality level requested by the data packet to a header data section of the data packet to be transmitted and transmits the data packet, and the second node receives the data packet, calculates a time difference between the reception time of the data packet and the transmission time of the header data section, and judges whether or not a value of the time difference exceeds a transmission delay allowable time defined in a service quality level. If this does not exceed, the second node receives the data packet and replies a response signal, and if this exceeds, the second node discards the data packet and does not reply the response signal. Consequently, in the data communication, the communication control based on the service quality property requested by an application server of a high order can be easily attained and mounted in a network layer.

Japanese Laid Open Patent Application (JP-A-Heisei, 11-331167) describes a quality data transmitting apparatus. In the quality data transmitting apparatus, a first transmitting section is provided to transmit a user data and a second transmitting section is provided to separate at least one quality data based on a reception signal from the user data and transmitting. Thus, only the quality data can be transmitted at any time, and a receiving side can take out only the quality data.

### SUMMARY

Therefore, the present invention provides a measuring system and a measuring method, in which a distribution quality of packets can be measured without performing any process on the packets.

In an exemplary aspect of the present invention, a measuring system of video image distribution quality includes a distribution server, a receiving terminal, an upstream side reception time data generating section, a downstream side reception time data generating section and a quality data measuring section. The distribution server is provided in a center to transmit packets for a video image through a network, and the receiving terminal is provided in a user home to receive the packets transmitted through the network from the distribution server. The upstream side reception time data generating section is provided in the center to generate an upstream side reception time data indicating a time when the distribution server transmits one of the packets. The downstream side reception time data generating section is provided for the user home to generate a downstream side reception time data indicating a time when the receiving terminal receives the packet. The quality data measuring section is provided for one of the center and the user home, to measure a distribution quality indicating a distribution state from the distribution server to the receiving terminal based on the upstream side reception time data and the downstream side reception time data.

In another exemplary aspect of the present invention, a measuring apparatus used in a distribution quality measuring system comprising a distribution server provided in a center to transmit packets for a video image to a network, and a receiving terminal provided in a user home to receive the packets transmitted through the network from the distribution server. The measuring apparatus includes an upstream side reception time data generating section provided for the center to generate and transmit an upstream side reception time data indicating a time when the distribution server transmits each of the packets; a downstream side reception time data generating section provided for the user home to generate and transmit a downstream side reception time data indicating a time when the receiving terminal receives each of the packets; and a quality data measuring section provided for one of the center and the user home to measure distribution quality of the packets distributed from the distribution server to the receiving terminal based on the upstream side reception time data and the downstream side reception time data.

Also, in another exemplary aspect of the present invention, a method of measuring a distribution quality, is achieved by transmitting packets for a video image to a network from a distribution server provided in a center; by receiving the packets transmitted through the network from the distribution server by a receiving terminal provided in a user home; by generating an upstream side reception time data indicating a time when the distribution server transmits each of the packets, by an upstream side reception time data generating section provided for the center; by generating a downstream side reception time data indicating a time when the receiving terminal receives each of the packets, by a downstream side reception time data generating section provided for the user home; and by measuring distribution quality of the packets distributed from the distribution server to the receiving terminal based on the upstream side reception time data and the downstream side reception time data, by a quality data measuring section provided for one of the center and the user home.

### BRIEF DESCRIPTION OF THE DRAWINGS

The above and other objects, advantages and features of the present invention will be more apparent from the following description of exemplary embodiments made in conjunction with the attached drawings, in which:

FIG. 1 is a diagram showing an entire configuration of a measuring system of distribution quality of a video image according to a first exemplary embodiment of the present invention;

FIG. 2 is a block diagram showing configurations of an upstream side measuring unit and a downstream side measuring unit in the first exemplary embodiment;

FIG. 3 is a block diagram showing a configuration of a quality data measuring section in the first exemplary embodiment;

FIG. 4 is a flowchart showing an operation of the upstream side measuring unit in the first exemplary embodiment;

FIG. 5 is a flowchart showing an operation of the downstream side measuring unit in the first exemplary embodiment;

FIG. 6 is a flowchart showing an operation of a reception time data generating section in the first exemplary embodiment;

FIG. 7 is a diagram showing a configuration of an RTP header in an RTP packet used in the first exemplary embodiment;

FIG. 8 is a diagram showing one example of a reception time data used in the first exemplary embodiment;

FIG. 9 is a diagram showing a configuration of an IP header in an IP packet used in the first exemplary embodiment;

FIG. 10 is a diagram showing a division example when the RTP packet is converted into the IP packets in the first exemplary embodiment;

FIG. 11 is a diagram showing another example of the reception time data in the first exemplary embodiment;

FIG. 12 is a flowchart showing an operation of a reception time comparing section in the first exemplary embodiment;

FIG. 13 is a flowchart showing an operation of a packet discard rate measuring section in the first exemplary embodiment;

FIG. 14 is a flowchart showing an operation of a jitter measuring section in the first exemplary embodiment;

FIG. 15 is a diagram showing an entire configuration of an application example of the measuring system of distribution quality of the video image according to a second exemplary embodiment of the present invention;

FIG. 16 is a block diagram showing configurations of the upstream side measuring unit and the downstream side measuring unit in the second exemplary embodiment;

FIG. 17 is a block diagram showing a configuration of a hash value quality data measuring section in the second exemplary embodiment;

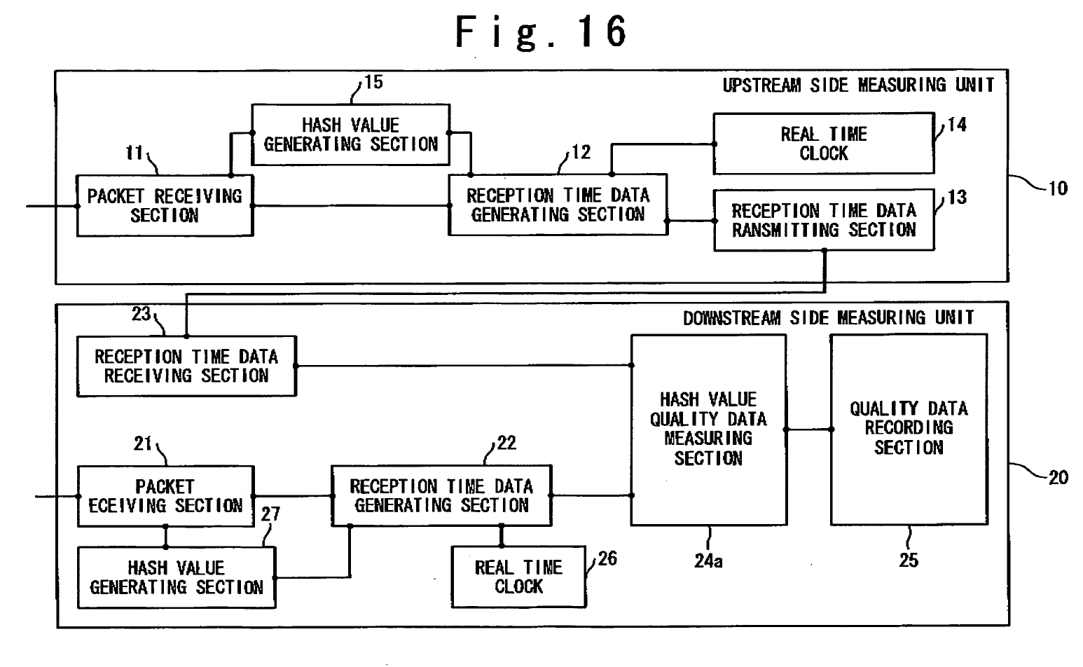

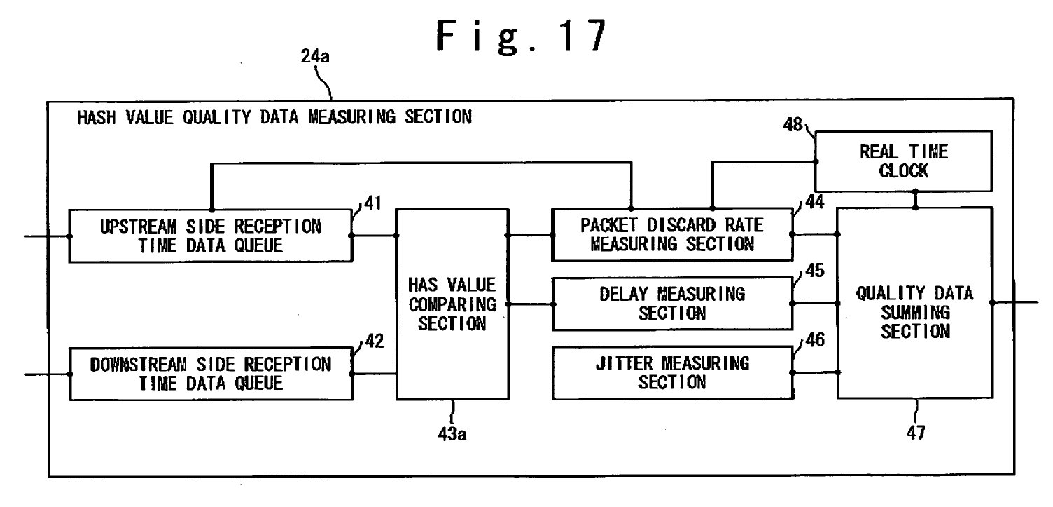

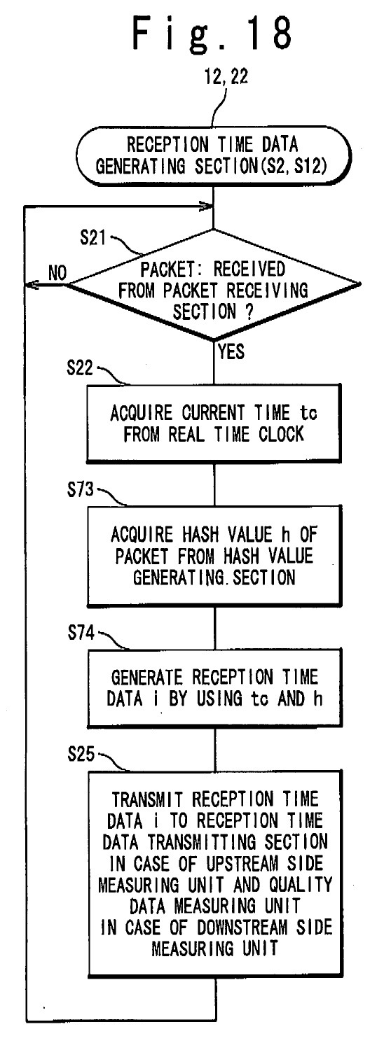

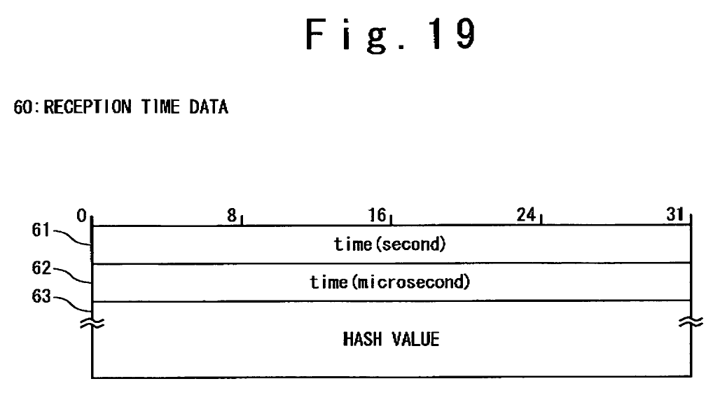

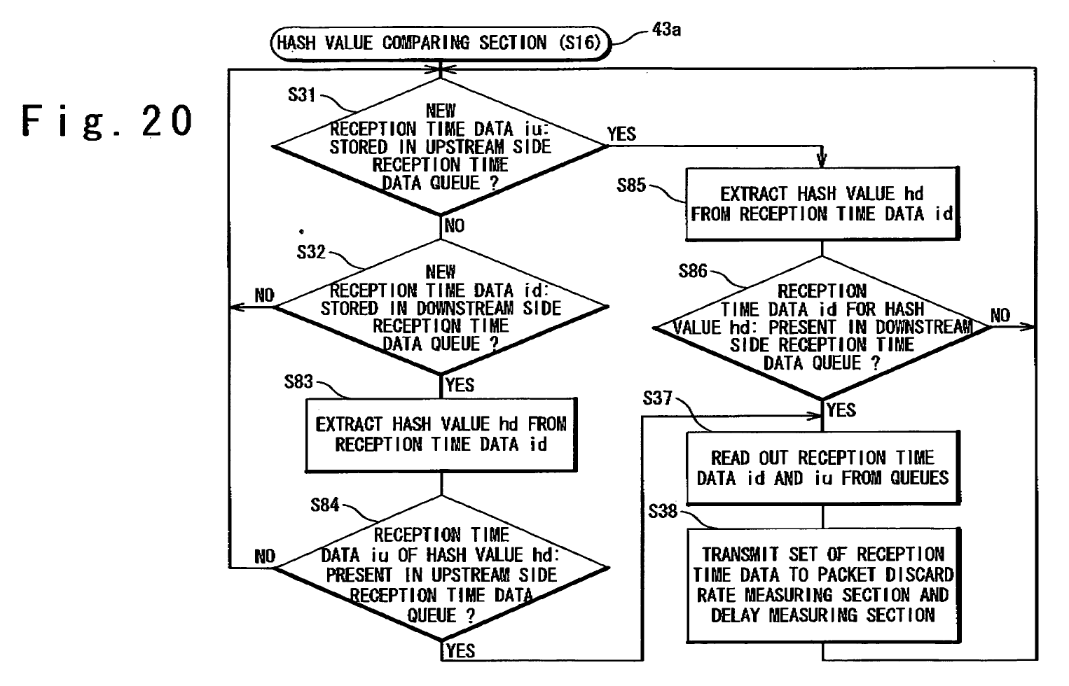

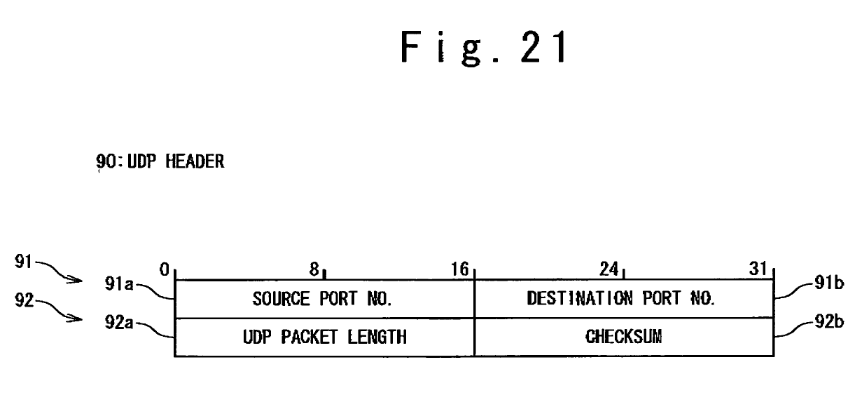

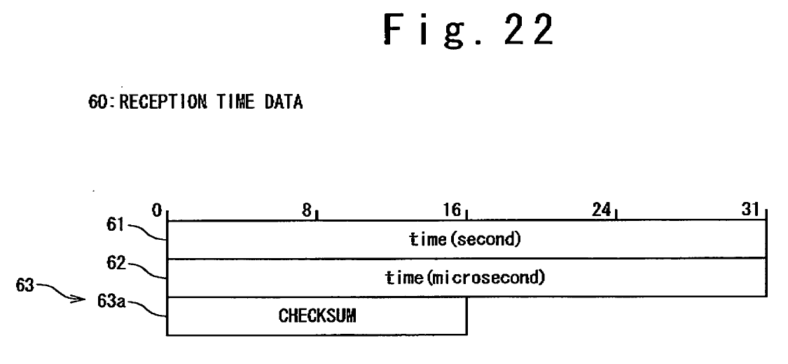

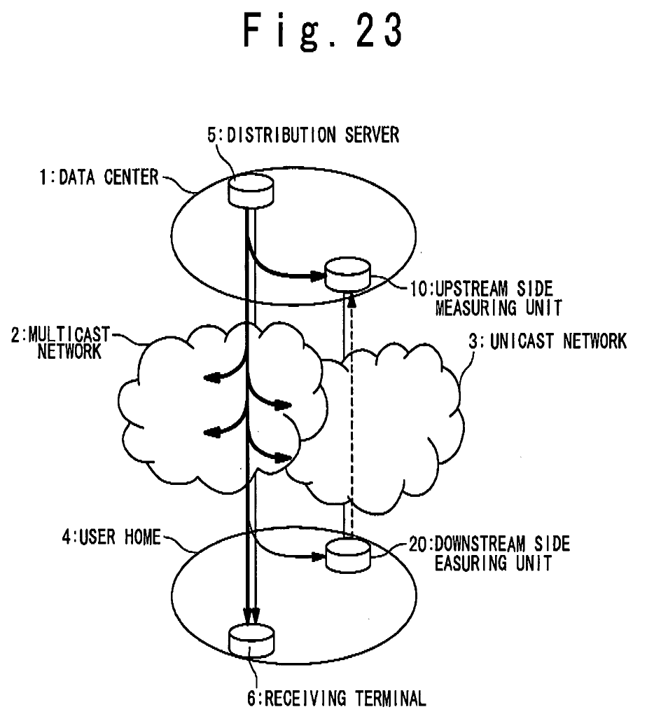

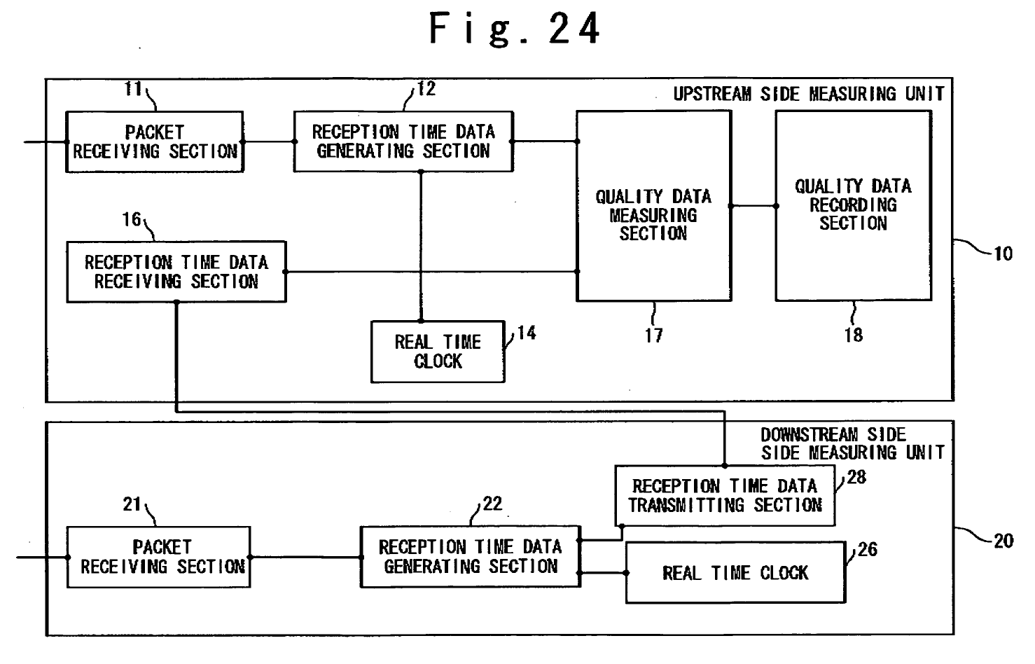

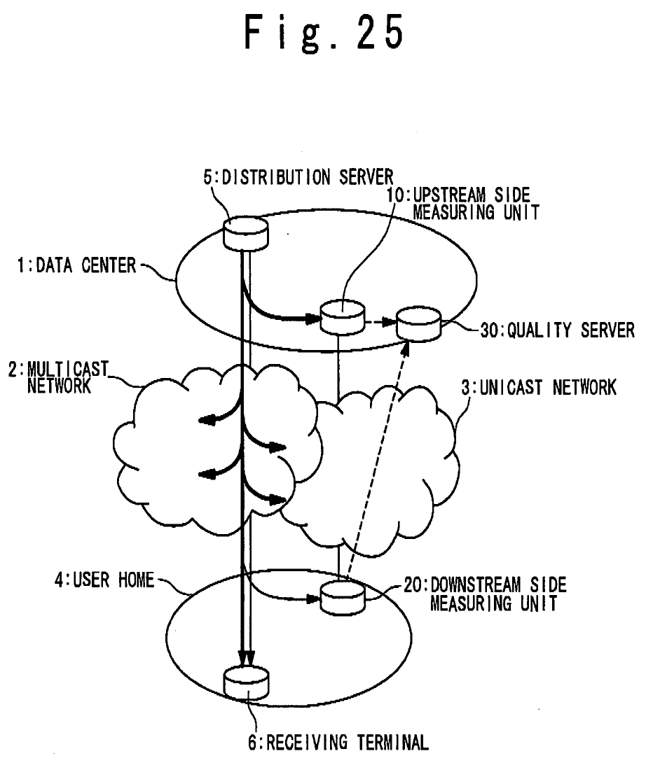

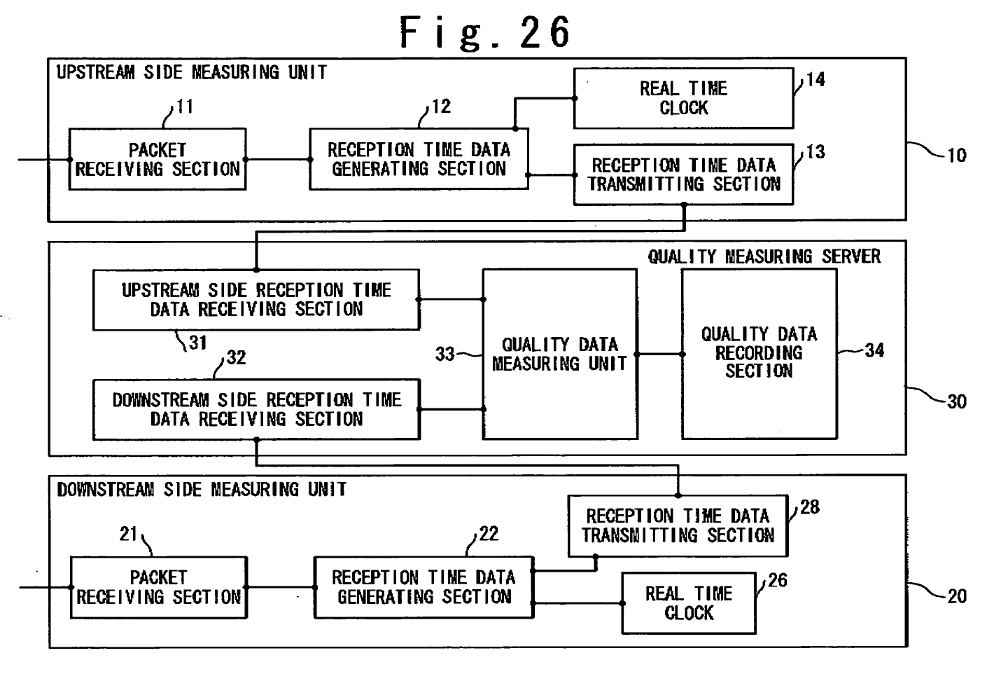

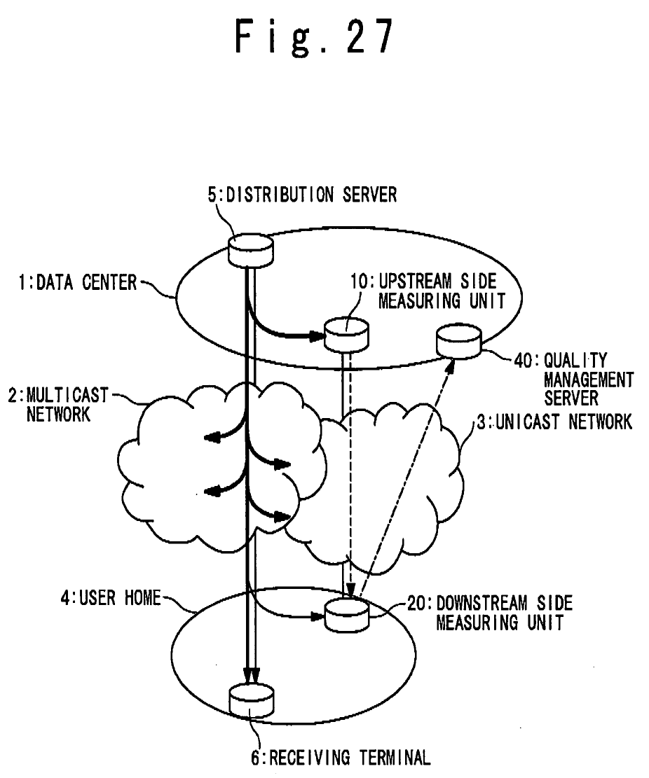

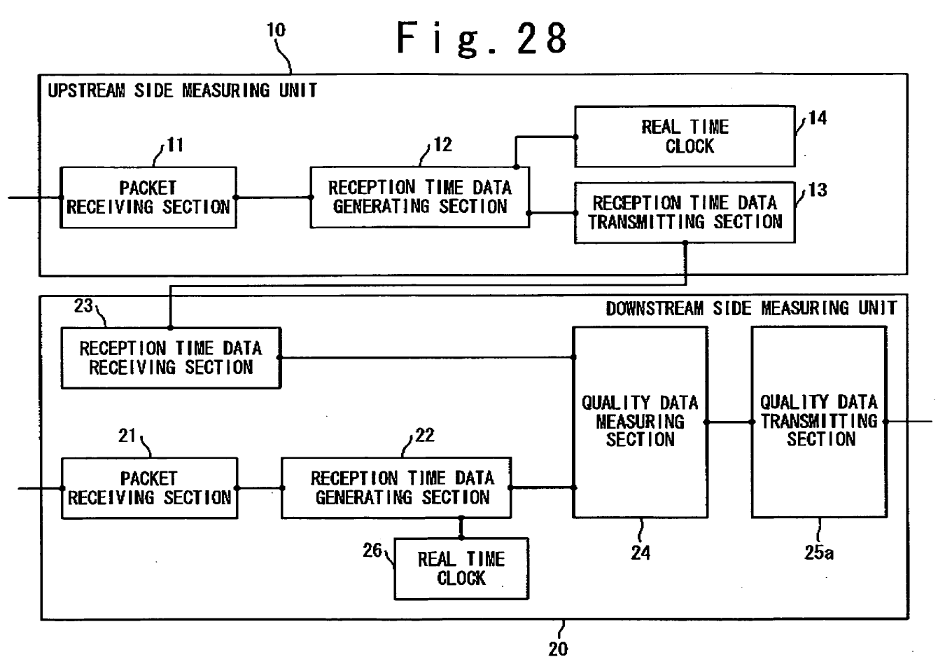

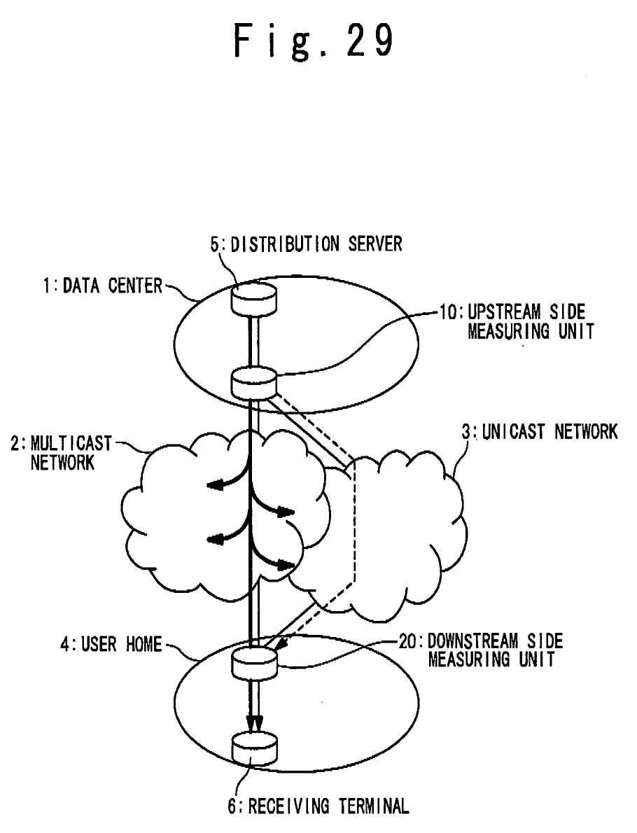

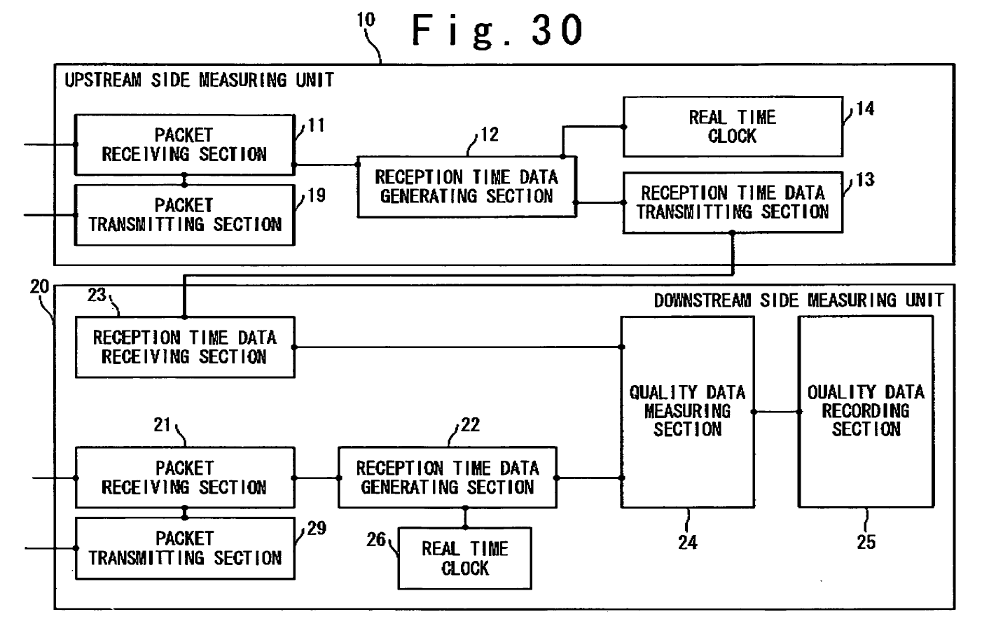

FIG. 16 is a flowchart showing an operation of a reception time data generating section in the second exemplary embodiment;

FIG. 19 is a diagram showing a reception time data in the second exemplary embodiment;

FIG. 20 is a flowchart showing an operation of a hash value comparing section in the second exemplary embodiment;

FIG. 21 is a diagram showing a configuration of a UDP header of a UDP packet in the second exemplary embodiment;

FIG. 22 is a diagram showing one example of the reception time data in the second exemplary embodiment;

FIG. 23 is a diagram showing an entire configuration of the measuring system of video image distribution quality according to a third exemplary embodiment of the present invention;

FIG. 24 is a block diagram showing configurations of the upstream side measuring unit and the downstream side measuring unit in the third exemplary embodiment;

FIG. 25 is a diagram showing an entire configuration of the measuring system of video image distribution quality according to a fourth exemplary embodiment of the present invention;

FIG. 26 is a block diagram showing configurations of the upstream side measuring unit, the downstream side measuring unit and a quality measuring server in the fourth exemplary embodiment;

FIG. 27 is a diagram showing an entire configuration of the measuring system of video image distribution quality according to a fifth exemplary embodiment of the present invention;

FIG. 28 is a block diagram showing configurations of the upstream side measuring unit and a downstream side measuring unit in the fifth exemplary embodiment;

FIG. 29 is a diagram showing an entire configuration of the measuring system of video image distribution quality according to a sixth exemplary embodiment of the present invention;

FIG. 30 is a block diagram showing configurations of the upstream side measuring unit and the downstream side measuring unit in the sixth exemplary embodiment; and

FIG. 31 is a diagram showing an entire configuration of the measuring system of video image distribution quality according to a seventh exemplary embodiment of the present invention.

### EXEMPLARY EMBODIMENTS

Hereinafter, exemplary embodiments of a measuring system of video image distribution quality of the present invention will be described in detail with reference to the attached drawings.

### First Exemplary Embodiment

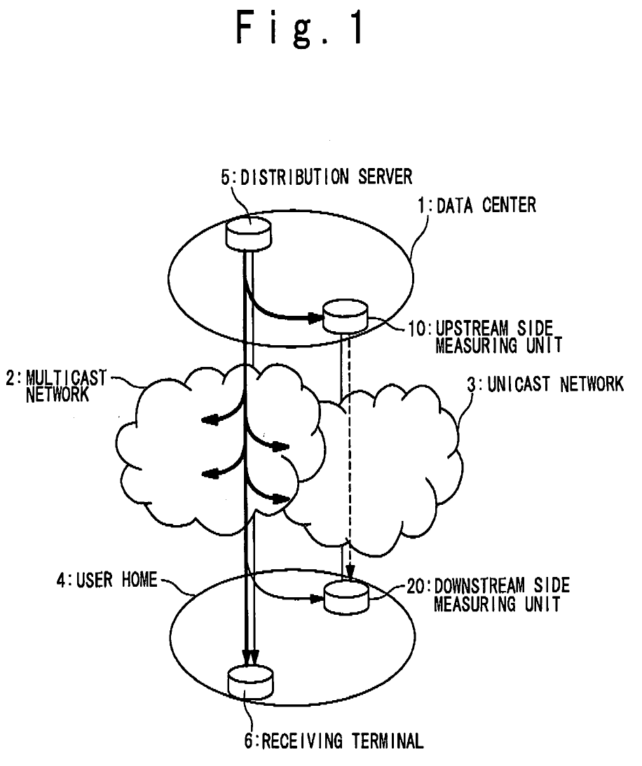

FIG. 1 shows a configuration of a measuring system of quality of distributed video image data according to a first exemplary embodiment of the present invention. Referring to FIG. 1, the measuring system according to the first exemplary embodiment contains a multicast network 2, a unicast network 3, a distribution server 5, a receiving terminal 6 and a measuring apparatus of quality of distributed vide image data. The distribution server 5, the receiving terminal 6 and the measuring apparatus may be computers. The measuring apparatus contains an upstream side measuring apparatus 10 and a downstream side measuring apparatus 20. The distribution server 5 and the upstream side measuring apparatus 10 are installed in a data center 1. The upstream side measuring apparatus 10 is connected to the distribution server 5 in the data center 1. The distribution server 5 in the data center 1 transmits packets of video image data to the multicast network 2. Each packet (multicast packet) transmitted from the distribution server 5 is distributed through the multicast network 2 to each user home 4.

The receiving terminal 6 and the downstream side measuring apparatus 20 are installed in each of a plurality of user homes 4. The downstream side measuring apparatus 20 is connected to the receiving terminal 6 in each user home 4. The receiving terminal 6 in each user home 4 receives the multicast packets and reproduces the video image data indicated by the multicast packets.

The multicast network 2 is a network to which a multicast technique is applied to distribute the video image data. The multicast network 2 is connected to the distribution server 5 and the receiving terminals 6. The unicast network 3 is a network to which a unicast technique is applied to measure the distribution quality of the multicast packets (also, to be referred to as a quality data). The unicast network 3 is connected to the upstream side measuring apparatus 10 and the downstream side measuring apparatus 20.

The upstream side measuring apparatus 10 is connected to the distribution server 5. The distribution server 5 transmits the multicast packets to the multicast network 2 and the upstream side measuring apparatus 10. The upstream side measuring apparatus 10 generates an upstream side reception time data indicating reception time on the upstream side when receiving the multicast packet, as a time when the distribution server 5 transmits the multicast packet, and transmits through the unicast network 3 to the downstream side measuring apparatus 20.

The downstream side measuring apparatus 20 is further connected to the multicast network 2. The receiving terminal 6 and the downstream side measuring apparatus 20 receive the multicast packets transmitted through the multicast network 2 from the distribution server 5. The downstream side measuring apparatus 20 generates a downstream side reception time data indicating reception time on the downstream side when receiving the multicast packet, as a time when the receiving terminal 6 receives the multicast packet. Also, the downstream side measuring apparatus 20 receives the upstream side reception time data transmitted through the unicast network 3 from the upstream side measuring apparatus 10. The downstream side measuring apparatus 20 measures the distribution quality when the distribution server 5 distributes the packets to the receiving terminal 6, based on the upstream side reception time data and the downstream side reception time data.

Here, in FIG. 1, the unicast network 3 and the multicast network 2 are provided as the networks different from each other. However, they may be provided as a single network corresponding to both of the unicast and the multicast.

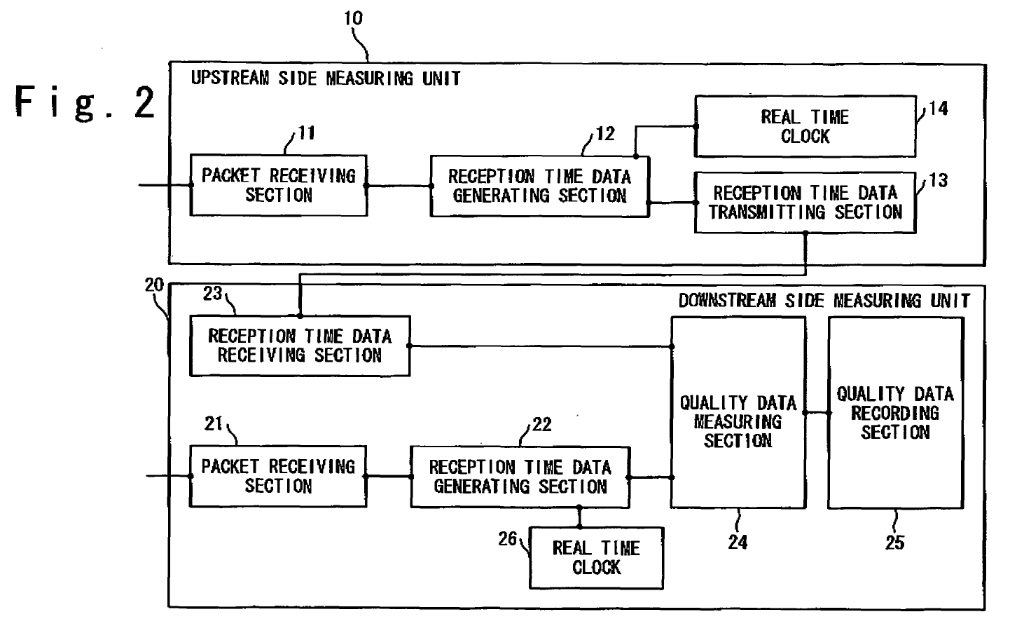

FIG. 2 is a block diagram showing the configurations of the upstream side measuring apparatus 10 and the downstream side measuring apparatus 20. In FIG. 2, the illustration of the unicast network 3 is omitted.

The upstream side measuring apparatus 10 contains an upstream packet receiving section 11, an upstream side reception time data generating section 12, an upstream side reception time data transmitting section 13, and a real time clock generating section 14, as its function blocks. The function block may be attained in hardware such as a circuit or in software such as a computer program. The packet receiving section 11 is connected to the distribution server 5 and the reception time data generating section 12. The reception time data generating section 12 is connected to the reception time data transmitting section 13 and the real time clock generating section 14. The reception time data transmitting section 13 is connected through the unicast network 3 to the downstream side measuring apparatus 20.

The downstream side measuring apparatus 20 contains a downstream packet receiving section 21, a reception time data generating section 22, a downstream side reception time data receiving section 23, a quality data measuring section 24, a quality data recording section 25 and a real time clock generating section 26, as its function blocks. The function block may be attained in hardware or in software. The packet receiving section 21 is connected to the multicast network 2 and the reception time data generating section 22. The reception time data generating section 22 is connected to the quality data measuring section 24 and the real time clock generating section 26. The reception time data receiving section 23 is connected through the unicast network 3 to the reception time data transmitting section 13 and connected to the quality data measuring section 24. The quality data measuring section 24 is connected to the quality data recording section 25.

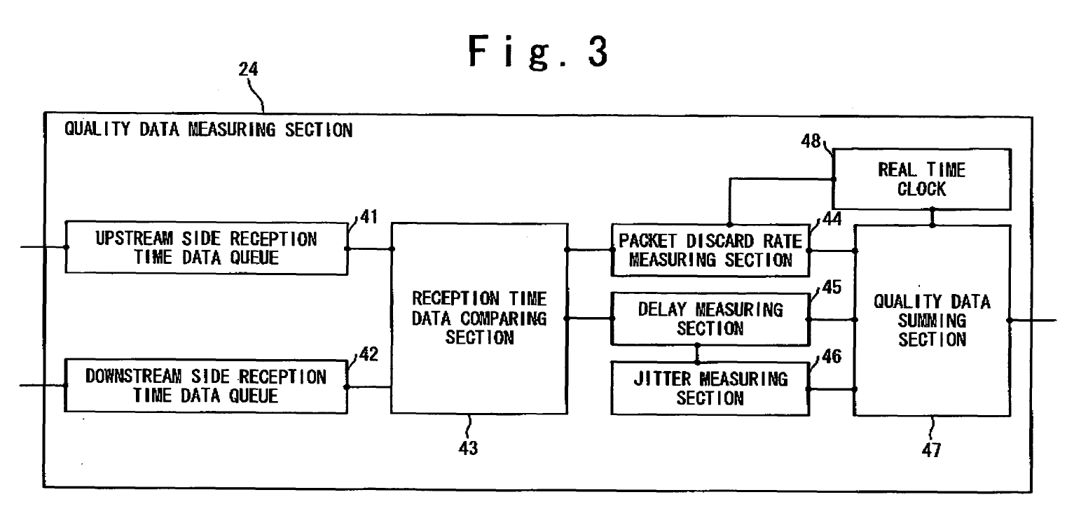

FIG. 3 is a block diagram showing the configuration of the quality data measuring section 24. The quality data measuring section 24 contains an upstream side reception time data queue 41, a downstream side reception time data queue 42, a reception time data comparing section 43, a distribution quality measuring section, a quality data summing section 47 and a real time clock generating section 48. The distribution quality measuring section contains a packet discard rate measuring section 44, a delay measuring section 45 and a jitter measuring section 46. The upstream side reception time data queue 41 is connected to the reception time data receiving section 23 and the reception time data comparing section 43. The downstream side reception time data queue 42 is connected to the reception time data generating section 22 and the reception time data comparing section 43. The reception time data comparing section 43 is connected to the packet discard rate measuring section 44 and the delay measuring section 45. The packet discard rate measuring section 44 is connected to the quality data summing section 47 and the real time clock generating section 48. The delay measuring section 45 is connected to the jitter measuring section 46 and the quality data summing section 47. The jitter measuring section 46 is connected to the quality data summing section 47. The quality data summing section 47 is connected to the real time clock generating section 48 and the quality data recording section 25.

The measuring system according to the first exemplary embodiment of the present invention will be described below with regard to the operations of the upstream side measuring apparatus 10 and the downstream side measuring apparatus 20. The upstream side measuring apparatus 10 and the downstream side measuring apparatus 20 operate when their power sources (not shown) are turned on.

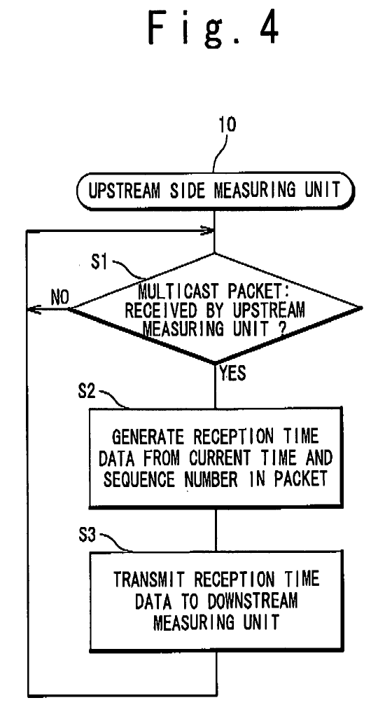

FIG. 4 is a flowchart showing the operation of the upstream side measuring apparatus 10. The packet receiving section 11 receives the multicast packets sent from the distribution server 5 and sends a response to the reception time data generating section 12 (Step S1—YES). The real time clock generating section 14 notifies a current time to the reception time data generating section 12. The reception time data generating section 12 defines the current time as the upstream side reception time and generates an upstream side reception time data, which includes a sequence number (which will be described later) in the packets sent from the packet receiving section 11 and an upstream side reception time. The reception time data generating section 12 sends the upstream side reception time data to the reception time data transmitting section 13 (Step S2). The reception time data transmitting section 13 sends a reception time data sent from the reception time data generating section 12 through the unicast network 3 to the downstream side measuring apparatus 20 (Step S3).

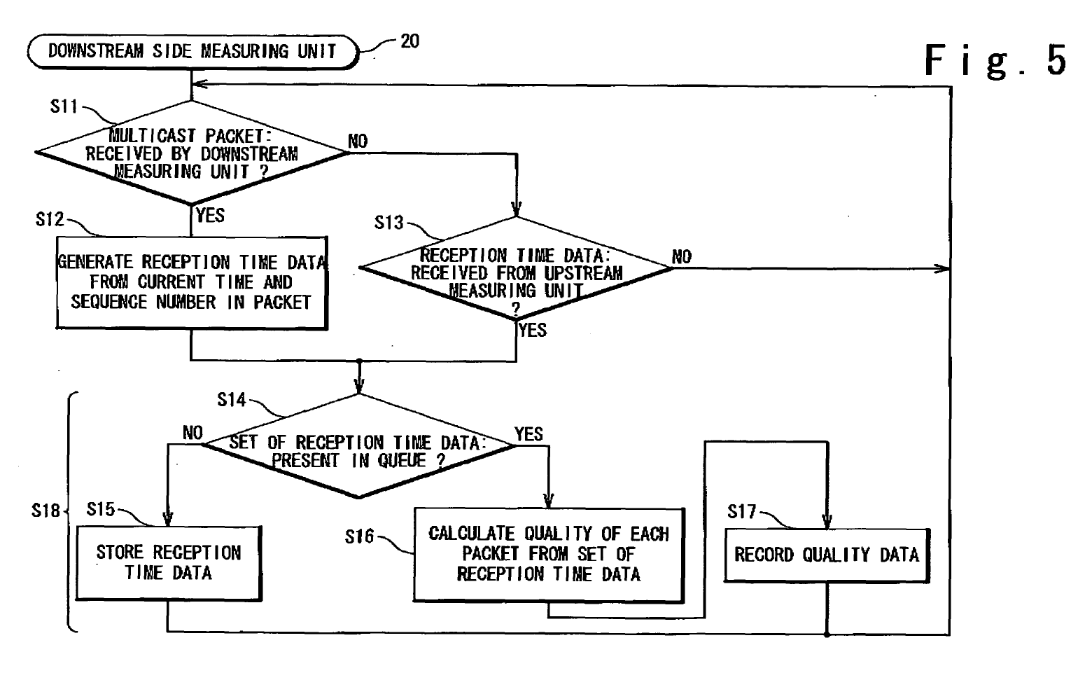

FIG. 5 is a flowchart showing the operation of the downstream side measuring apparatus 20.

The packet receiving section 21 receives the multicast packets, which are sent through the multicast network 2 from the distribution server 5, and sends to the reception time data generating section 22 (Step S11—YES). The real time clock generating section 26 notifies the current time to the reception time data generating section 22. The reception time data generating section 22 defines the current time as the downstream side reception time and generates the downstream side reception time data, which includes the sequence number (that will be described later) sent from the packet receiving section 21 and the downstream side reception time, and sends to the quality data measuring section 24 (Step S12).

The reception time data receiving section 23 receives the reception time data sent through the unicast network 3 from the upstream side measuring apparatus 10 and sends to the quality data measuring section 24 (Steps S11—NO, S13—YES). The quality data measuring section 24 measures the distribution quality in accordance with the upstream side reception time data sent from the reception time data receiving section 23 and the downstream side reception time data sent from the reception time data generating section 22 and records the measured distribution quality in the quality data recording section 25 (Step S18). The distribution quality includes a transmission delay of each packet, jitter noise and a discard rate of the packets per predetermined time. A process performed by the quality data measuring section 24 in the downstream side measuring apparatus 20 at the step S18 will be described below in detail.

The upstream side reception time data queue 41 stores the upstream side reception time data sent from the reception time data receiving section 23. On the other hand, the downstream side reception time data queue 42 stores the downstream side reception time data sent from the reception time data generating section 22 (Steps S14—NO, S15—YES).

The reception time data comparing section 43 monitors that the upstream side reception time data and the downstream side reception time data are stored in the upstream side reception time data queue 41 and the downstream side reception time data queue 42, respectively. The reception time data comparing section 43 compares the upstream side reception time data and the downstream side reception time data. In this case, the upstream side reception time data and the downstream side reception time data are stored, between which the sequence numbers are coincident. In that case, the reception time data comparing section 43 reads the upstream side reception time data and the downstream side reception time data from the upstream side reception time data queue 41 and the downstream side reception time data queue 42, respectively, and defines them as one set. Then, the reception time data comparing section 43 sends to the packet discard rate measuring section 44 and the delay measuring section 45 (Step S14—YES).

Next, as the distribution quality, the transmission delay of the packet, the jitter and the discard rate of the packet per constant time are measured (Step S16). The real time clock generating section 48 notifies the current time to the packet discard rate measuring section 44 and the quality data summing section 47.

At a step S16, the packet discard rate measuring section 44 measures a predetermined time on the basis of the time notified from the real time clock generating section 48. This packet discard rate measuring section 44 calculates a discard rate of the packets per the predetermined time based on the set of the reception time data sent from the reception time data comparing section 43 and sends the calculated discard rate to the quality data summing section 47. The discard rate of the packets indicates the number of the packets that are not received by the downstream side measuring apparatus 20, with respect to the number of the packets received by the upstream side measuring apparatus 10, for the predetermined time. This detail will be described later.

At the step S16, the delay measuring section 45 calculates the transmission delay of the packet based on the set of the reception time data sent from the reception time data comparing section 43 and sends the calculated transmission delay to the quality data summing section 47 and the jitter measuring section 46. The transmission delay indicates a time between the upstream side reception time data and the downstream side reception time data. This detail will be described later.

At the step S16, the jitter measuring section 46 calculates jitter based on the calculated value of the transmission delay sent from the delay measuring section 45 and sends the calculated jitter amount to the quality data summing section 47. The jitter indicates a difference between the transmission delay in the packet including a certain sequence number and the transmission delay in the packet that includes the sequence number previous by one. This detail will be described later.

The quality data summing section 47 sums the discard rate of the packet per a predetermined time from the packet discard rate measuring section 44, the transmission delay of the packet from the delay measuring section 45, and the jitter from the jitter measuring section 46. The quality data summing section 47 records the distribution quality including them together with the time notified by the real time clock generating section 48 in the quality data recording section 25 (Step S17).

In this way, in the measuring system according to the first exemplary embodiment of the present invention, the distribution quality can be measured without performing any processing on the packet.

As mentioned above, in the downstream side measuring apparatus 20, there are the real time clock generating section 26 and the real time clock generating section 48 of the quality data measuring section 24. However, the existence of the plurality of generating sections is not always required. For example, the real time clock generating section 26 may be responsible for the role of the two real time generating sections.

Also, the real time clock generating sections 26 and 48 are required to be synchronous in time with the real time clock generating section 14 in the upstream side measuring apparatus 10. In the time synchronization between two points on a network, a calculation is executed on the basis of the RTT and the reception time, and the times are synchronized. As for the protocol of the time synchronization, for example, there are NTP (RFC1305), SNTP (RFC2030) and the like, and they may be used. Also, another time synchronizing device may be employed. For example, the synchronization may be executed by using an external device such as an electric wave watch. Also, the real time clock generating section of a high precision that does not require the execution of a periodic synchronization may be used.

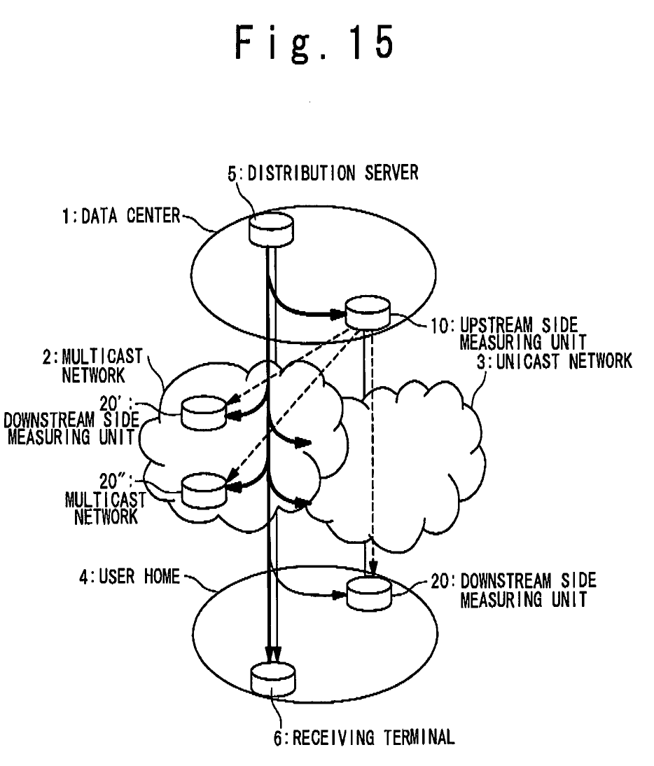

Also, as mentioned above, the downstream side measuring apparatus 20 is provided in the user home 4 and measures the distribution quality with regard to the packet arriving at the user home 4. As shown in FIG. 15, downstream side measuring apparatuses 20′ and 20″ may be further provided in the multicast network 2 as the downstream side measuring apparatus 20. The downstream side measuring apparatuses 20′ and 20″ are provided under the management of a plurality of routers. In this way, by using the downstream side measuring apparatuses 20′ and 20″ provided in the multicast network 2, the distribution quality can be measured until each position (router) of the multicast network 2. Also, as shown in FIG. 15, when there are a large number of downstream side measuring apparatuses 20, the transmission of the upstream side reception time data from the upstream side measuring apparatus 10 may be done by using the multicast network 2.

At the above step S1, the packet receiving section 11 of the upstream side measuring apparatus 10 may perform the operation as described below. The packet receiving section 11 may receive only the packets, which are matched with an address and port number that is specified in advance through a configuration, and send the packets to the reception time data generating section 12. Also, the packet receiving section 11 may receive only the packets in which a particular flag is set or the packets only when a particular value is written in a particular field. As the method of receiving only the value, for example, the following method may be adopted in which a typical image distribution is performed in its original state, and when a new multicast packet dedicated to a measurement is sent, a value different from the other fields is written for a flow label that is a field to identify a flow in IPv6, for the purpose of the discrimination from the typical multicast packet, and only the packet of its value is targeted for the measurement.

At the above step S2, the reception time data generating section 12 in the upstream side measuring apparatus 10 may perform the operation as described below. The reception time data generating section 12 may generate the upstream side reception data, which includes only the sequence number and does not include the upstream side reception time, as the upstream side reception time data. In this case, the downstream side measuring apparatus 20 can measure only the discard rate of the packet. Also, in the reception time data generating section 12, the result in which the numbers of the packets received for each predetermined time are collected may be defined as the reception data. In this case, although the downstream side measuring apparatus 20 can perform only the measurement of the packet discard rate, this can reduce a load on the process and the communication.

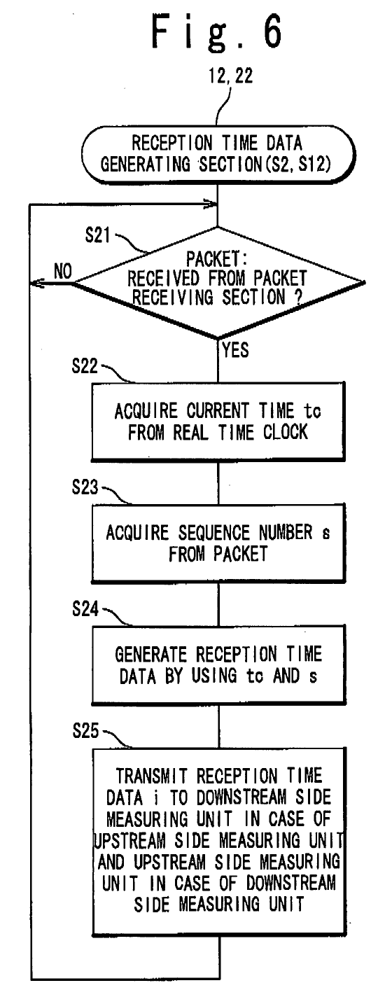

The processes performed at the steps S2 and S12 by the reception time data generating section 12 in the upstream side measuring apparatus 10 and the reception time data generating section 22 in the downstream side measuring apparatus 20 will be described in detail with reference to FIG. 6.

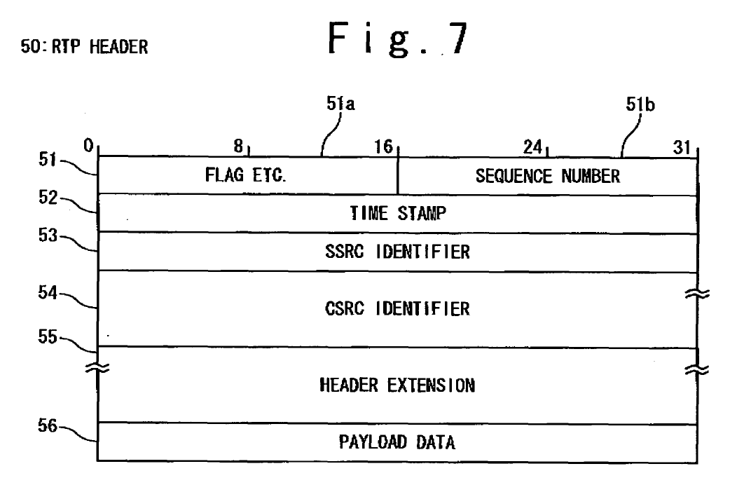

At first, the reception time data generating sections 12 and 22 wait for the arrival of the packets sent from the packet receiving sections 11 and 21, respectively (Step S21). When the packets are sent, the reception time data generating sections 12 and 22 acquire current times tc from the real time clock generating section 14 and 26, respectively (Step S22). Next, the reception time data generating sections 12 and 22 refer to the packets transmitted from the packet receiving sections 11 and 21 and extract the sequence numbers included in the packets (Step S23). Here, the sequence number is, for example, a value stored in the field of the RTP header of the packet. Specifically, as shown in FIG. 7, the RTP header 50 has fields 51 to 56 of 32 bits. The fields 52, 53, 54, 55 and 56 store the values indicating a time stamp, an SSRC identifier, a CSRC identifier, a header expansion, a payload data, respectively. The field 51 has a field 51a of 16 lower bits and a field 51b of 16 higher bits, and the fields 51a and 51b store the values indicating a flag and a sequence number, respectively.

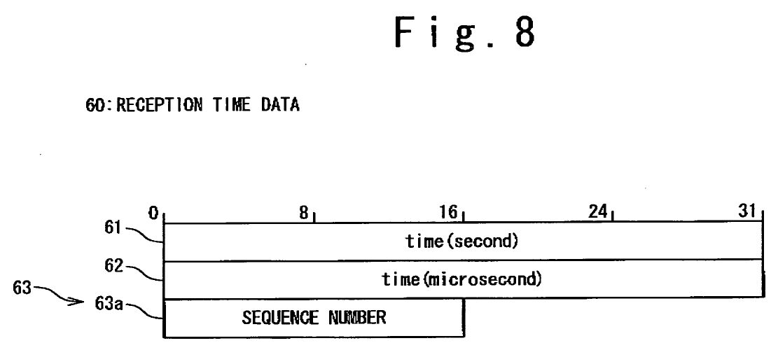

Next, the reception time data generating sections 12 and 22 define the current times tc obtained at the step S22 as the upstream side reception time and the downstream side reception time, respectively, and generate a reception time data i, which includes the current time tc and a sequence number s obtained at the step S23 (Step S24). Here, as shown in FIG. 8, the reception time data 60 as the reception time data i has fields 61 and 62 of 32 bits and a field 63. The fields 61 and 62 store the time with 1970/1/10:00 as epoch. The field 63 has a filed 63a of 16 lower bits, and the field 63a stores a value indicating the sequence number. Here, the lengths of the fields for the current time to be set are 32 bits, respectively. However, the field lengths may be different, as necessary.

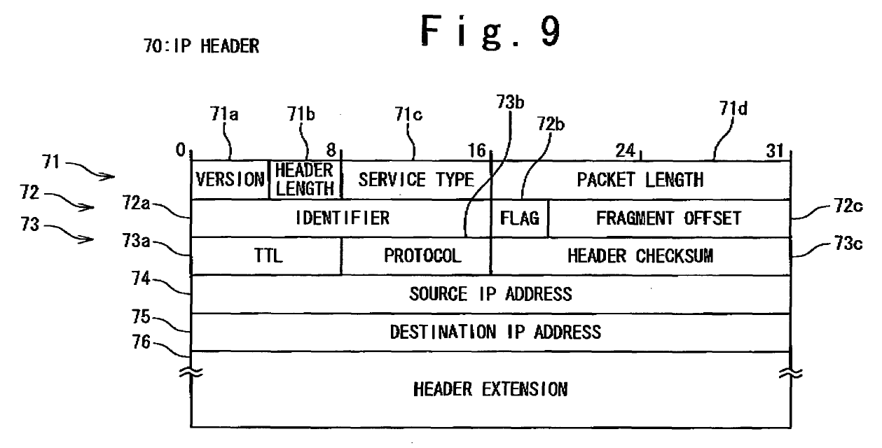

Next, the reception time data generating sections 12 and 22 send the generated reception time data i to the reception time data transmitting section 13 and the quality data measuring section 24, respectively (Step S25). At the step S24, the reception time data generating sections 12 and 22 may perform the operation as described below. For example, a set of values of an identifier and an fragment offset that are stored in the field in the IP header of the packet may be used instead of the sequence number. Specifically, as shown in FIG. 9, an IP header 70 has fields 71 to 76 of 32 bits. The fields 74, 75 and 76 store the values indicating a transmission source IP address, a destination IP address and a header extension, respectively. The field 71 has fields 71a, 71b, 71c and 71d in an order from the lower bit position side. The fields 71a, 71b, 71c and 71d store the values indicating a version, a header length, a service type and a packet length, respectively. The field 72 has fields 72a, 72b and 72c in an order from the lower bit position side. The fields 72a, 72b and 72c store data indicating an identifier, a flag and a fragment offset, respectively. The field 73 has fields 73a, 73b and 73c in an order from the lower bit position side. The fields 73a, 73b and 73c store the values indicating TTL, a protocol and a header checksum, respectively.

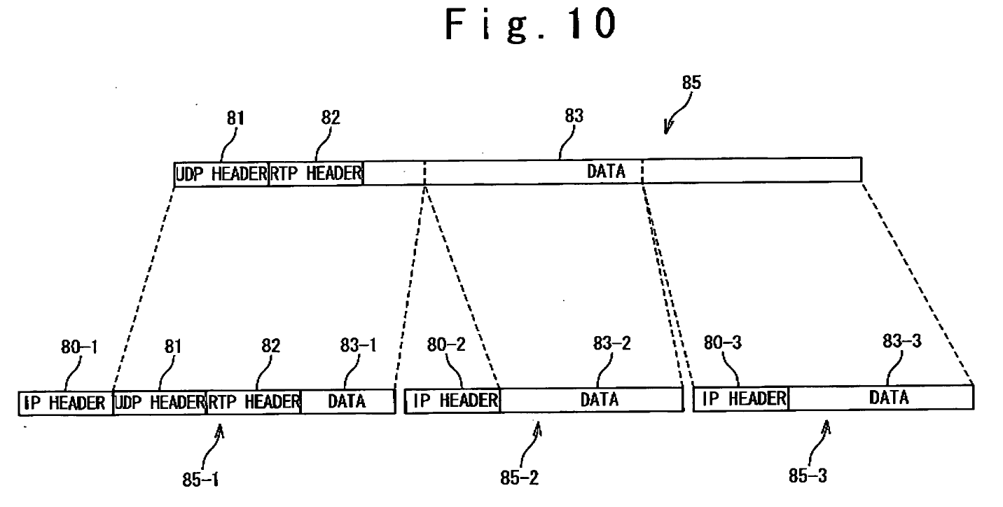

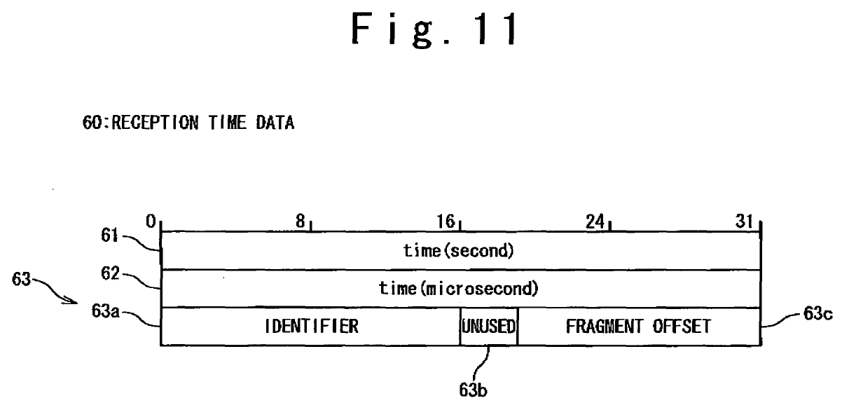

In the foregoing method, in order to use the RTP header 50, the process is performed in units of the RTP packets. When the data size of the RTP packet is large, the packet is divided upon assignment of the IP header and transmitted. Specifically, as shown in FIG. 10, a packet 85 includes a UDP header 81, an RTP header 82 and a data 83. When the data size of the RTP packet is large, the data 83 is required to be divided into division data 83-1 to 83-3. In this case, the packet 85 is divided into, for example, division packets 85-1 to 85-3 upon the assignment of the IP header 70. The division packet 95-1 includes an IP header 80-1 serving as the IP header 70, the UDP header 81, the RTP header 82 and the division data 83-1. The division packet 85-2 includes an IP header 90-2 serving as the IP header 70 and the division data 83-2. The division packet 85-3 includes an IP header 80-3 serving as the IP header 70 and the division data 93-3. An identification field 72a and a fragment offset field 72c in the IP header 70 are used when a destination reproduces the data 83 from the division data 83-1 to 83-3. The division packets 85-1, 85-2 and 85-3 have the same identifier. Also, in the fragment offset field 72c, the packet 65-1 that is a head fragment stores 0, and the other packets 85-2 and 85-3 store values in unit of 8 octets as their relative positions. Since the set of those values is used, the packet in the IP can be uniquely specified. When those values are used, the reception time data 60 is generated in not units of the RTP packets but units of the IP packets. At this time, as shown in FIG. 11, the field 63 of the reception time data 60 has fields 63a, 63b and 63c in an order from the lower bit position side. The fields 63a and 63c store data indicating the identifier and the fragment offset, respectively.

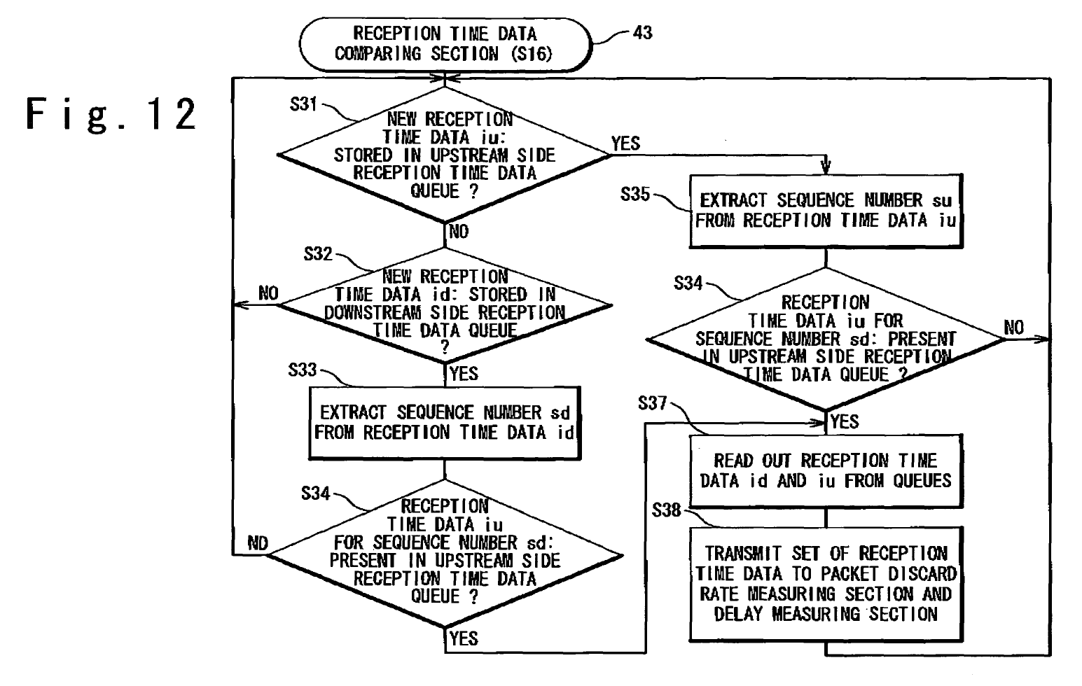

The process performed by the reception time comparing section 43 of the quality data measuring section 24 in the downstream side measuring apparatus 20 at the above step S16 will be described below in detail by using FIG. 12.

At first, the reception time comparing section 43 refers to the upstream side reception time data queue 41 and checks whether or not the upstream side reception time data 60 is newly stored (Step S31). Here, the new upstream side reception time data 60 does not exist (Step S31—NO). In this case, the reception time comparing section 43 refers to the downstream side reception time data queue 42 and checks whether or not the downstream side reception time data 60 is newly stored (Step S32). Here, the new downstream side reception time data 60 does not exist (Step S32—NO). In this case, the reception time comparing section 43 performs the step S31.

On the other hand, the new downstream side reception time data 60 exists (Step S32—YES). In this case, the reception time comparing section 43 extracts a sequence number sd from a downstream side reception time data id as the downstream side reception time data 60 newly stored in the downstream side reception time data queue 42 (Step S33). Next, the reception time comparing section 43 refers to the upstream side reception time data queue 41 and checks whether or not an upstream side reception time data iu including the sequence number sd exists as the upstream side reception time data 60 (Step S34). Here, if the reception time data 60 including the same sequence number sd does not exist (Step S34—NO), the step S31 is performed in this case. The fact that the reception time data 60 including the same sequence number sd does not exist implies that the upstream side reception time data including the sequence number sd does not still arrive at the downstream side measuring apparatus 20 from the upstream side measuring apparatus 10. In this case, the reception time comparing section 43 still stores the reception time data id in the downstream side reception time data queue 42, in order to perform the process after the arrival of the upstream side reception time data 60.

When referring to the upstream side reception time data queue 41 to confirm if the upstream side reception time data 60 is newly stored (Step S31—YES), the reception time comparing section 43 extracts the sequence number su from the upstream side reception time data iu as its upstream side reception time data 60 (Step 535). Next, the reception time comparing section 43 refers to the downstream side reception time data queue 42 and checks whether or not the downstream side reception time data id including the sequence number su (Step S36). Here, the reception time data 60 including the same sequence number sd does not exist (Step S34—NO). In this case, the step S31 is performed. The fact that the reception time data 60 including the same sequence number sd does not exist implies that since the packet including the sequence number sd does not still arrive at the downstream side measuring apparatus 20, the downstream side reception time data 60 is not still generated. Or, this implies that the packet including the sequence number sd is discarded in the multicast network 2. In this case, the reception time comparing section 43 still stores the upstream side reception time data in the upstream side reception time data queue, in order to perform the process after the generation of the downstream side reception time data 60.

The reception time comparing section 43 confirms the existence of the upstream side reception time data iu including the sequence number sd, as the result of the reference of the upstream side reception time data queue 41. That is, the reception time comparing section 43 confirms the existence of the upstream side reception time data iu including the same sequence number as the sequence number sd included in the downstream side reception time data id. Or, the reception time comparing section 43 refers to the downstream side reception time data queue 42 and confirms the existence of the downstream side reception time data id including the sequence number su. That is, the reception time comparing section 43 confirms the existence of the downstream side reception time data id including the same sequence number as the sequence number sd included in the upstream side reception time data iu (Step S36—YES). In this case, the reception time comparing section 43 takes out the upstream side reception time data iu and the downstream side reception time data id from the upstream side reception time data queue 41 and the downstream side reception time data queue 42, respectively (Step S37). The reception time comparing section 43 uses the upstream side reception time data iu and the downstream side reception time data id as one set, and sends the set to the packet discard rate measuring section 44 and the delay measuring section 45 (Step S38), and then performs the step S31.

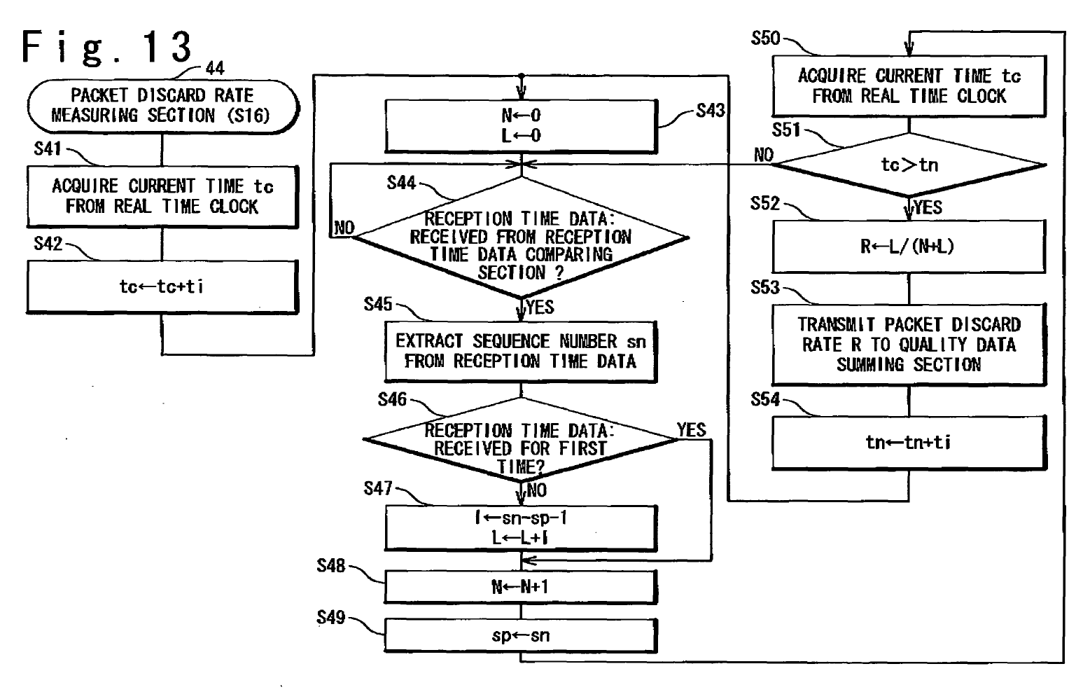

The process performed by the packet discard rate measuring section 44 of the quality data measuring section 24 in the downstream side measuring apparatus 20 at the step S16 will be described below in detail by using FIG. 13. Although being not shown, the packet discard rate measuring section 44 contains a measurement interval storing section, a variable N storing section, a variable L storing section, a variable I storing section and a variable sp storing section. The measurement interval storing section stores a predetermined measurement interval ti. The variable N storing section, the variable L storing section, the variable I storing section and the variable sp storing section store the variables N, L, I and sp, respectively.

At first, the packet discard rate measuring section 44 obtains the current time tc from the real time clock generating section 48 (Step S41) and determines a next update time tn obtained by adding the measurement period ti (Step S42). The packet discard rate is measured for each time period that is defined as the value of the measurement period ti. The next update time tn implies the time of the next determination of the packet discard rate. The packet discard rate measuring section 44 sets the value of 0 to the variables N, L (Step S43). The variable N is used to count the packets received during the measurement time period. The variable L is used to count the number of packets discarded during the measurement time period. Next, the packet discard rate measuring section 44 waits for the arrival of the reception time data 60 from the reception time data comparing section 43 (Step S44).

The reception time data comparing section 43 sends the reception time data 60 to the packet discard rate measuring section 44 (Step S44—YES). In this case, the packet discard rate measuring section 44 extracts the sequence number sn from the reception time data 60 (Step S45). The reception time data comparing section 43 sends the upstream side reception time data 60 and the downstream side reception time data 60 as one set. However, since they have the same sequence number, the packet discard rate measuring section 44 may extract the sequence number from any of the reception time data 60.

Next, if the reception time data 60 is firstly received after a power is turned on (Step S46—YES), the packet discard rate measuring section 44 adds 1 to the variable N (Step S48) and stores the sequence number sn of the packet received at this time in the variable sp storing section as the variable sp instead of the variable sp previously stored in the variable sp storing unit (Step S49). Next, the packet discard rate measuring section 44 obtains the current time tc from the real time clock generating section 48 (Step S50) and compares the current time tc and the next update time tn (Step S51).

On the other hand, if the reception of the reception time data 60 is not the first time after the power is turned on (Step S46—NO), the packet discard rate measuring section 44 determines the value that the value indicating the sequence number sp of the previously received packet is subtracted from the value indicating the extracted sequence number sn and 1 is further subtracted, and stores as the valuable I in the valuable I storing unit. Moreover, the value of the valuable I is added to the variable L (Step S47). Here, the valuable L indicates the number of the packets discarded on the network between the previously received packet and the currently received packet. Next, 1 is added to the valuable N (Step S48). Instead of the variable sp previously stored in the variable sp storing unit, the sequence number sn of the packet received at this time is stored in the variable sp storing section as the variable sp (Step S49). Next, the packet discard rate measuring section 44 obtains the current time tc from the real time clock generating section 48 (Step S50) and compares the current time tc and the next update time tn (Step S51).

Here, the current time does not pass through the next update time tn (Step S51—NO). In this case, the packet discard rate measuring section 44 performs the step S44.

On the other hand, the current time tc passes through the next update time tn (Step S51—YES). In this case, the packet discard rate measuring section 44 adds the variable L as the total number of the discarded packets within the measurement time period and the variable N as the total number of the reception packets, to calculate the variable (N+L). Then, the variable L is divided by the variable (N+L), and a packet discard rate R is consequently calculated (Step S52). Next, the packet discard rate measuring section 44 sends the calculated packet discard rate R to the quality data summing section 47 (Step S53). Moreover, in order to update the next update time tn, the value of the measurement period ti is added (Step S54), and the step S43 is performed.

The process performed by the delay measuring section 45 of the quality data measuring section 24 in the downstream side measuring apparatus 20 at the step S16 will be described below in detail. The delay measuring section 45 refers to the set of the upstream side reception time data 60 and the downstream side reception time data 60, which are sent from the reception time data comparing section 43, and calculates the time between the upstream side reception time included in the upstream side reception time data and the downstream side reception time included in the downstream side reception time data. Here, the calculated value indicates the transmission delay. The delay measuring section 45 sends the value indicating the transmission delay to the jitter measuring section 46 and the quality data summing section 47.

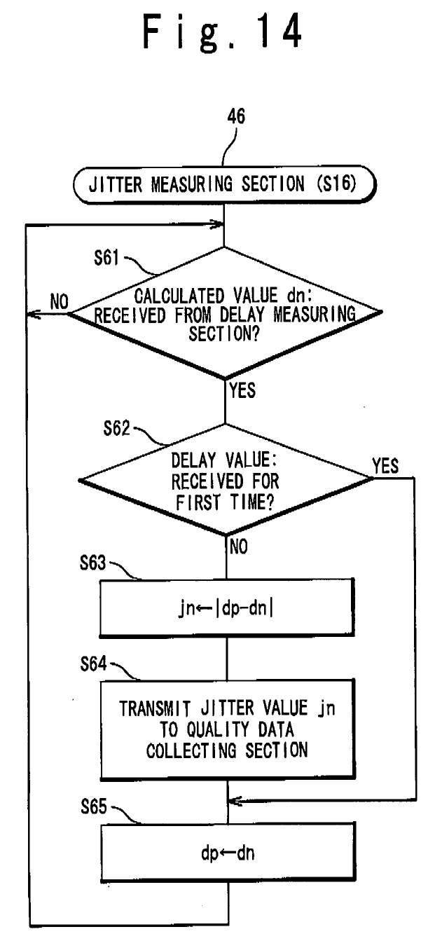

The process performed by the jitter measuring section 46 of the quality data measuring section 24 in the downstream side measuring apparatus 20 at the step S16 will be described below in detail by using FIG. 14. Although being not shown, the jitter measuring section 46 contains a variable dp storing unit. The variable dp storing section stores a variable dp.

At first, the jitter measuring section 46 waits for the arrival of the value dn indicating the transmission delay from the delay measuring section 45 (Step S61). Here, the delay measuring section 45 sends the value dn indicating transmission delay to the jitter measuring section 46 (Step S61—YES). Thus, if firstly receiving the value dn indicating the transmission delay after the power is turned on (Step S62—YES), the jitter measuring section 46 stores the value dn indicating the transmission delay received at this time, in the variable dp storing section as the variable dp (Step S65) Then, the step S61 is performed.

The delay measuring section 45 sends the value dn indicating transmission delay to the jitter measuring section 46 (Step S61—YES). Thus, if the reception of the value dn indicating the transmission delay is not the first time after the power is turned on (Step S62—NO), the jitter measuring section 46 calculates the value when the value dn indicating the transmission delay and sent from the delay measuring section 45 is subtracted from the variable dp stored in the variable dp storing unit, and defines its absolute value as a jitter jn (Step S63). The jitter measuring section 46 sends the value indicating the jitter jn to the quality data summing section 47 (Step S64). Instead of the variable dp previously stored in the variable dp storing unit, the jitter measuring section 46 stores the value dn indicating the transmission delay received at this time in the variable dp storing section as the variable dp (Step S65). Then, the step S61 is performed.

For example, it is supposed that the reception times of the upstream continuous packets are t1 and t2 and the downstream side reception times of those packets are s1 and s2. At this time, the transmission delays of the respective packets become s1−t1 and s2−t2. In the process performed by the jitter measuring section 46, those values become dp and dn, respectively. The jitter determined by using those values are jp=|dn−dp|=|(s2−t2)−(s1−t1)|=|s2−s1+t1−t2|.

The process performed by the upstream side reception time data queue 41 of the quality data measuring section 24 in the downstream side measuring apparatus 20 at the step S15 will be described below in detail. The upstream side reception time data queue 41 stores the upstream side reception time data 60 although the downstream side reception time data 60 serving as a part of the set does not still exist in the downstream side reception time data queue 42. In the multicast network 2, when the downstream side reception time data 60 cannot be generated from the discarded packet due to any reason, the upstream side reception time data 60 generated from the packet has been still left stored in the upstream side reception time data queue 41. For this reason, in the upstream side reception time data queue 41, any of the following methods is used to deal with this problem.

As the first method, an upper limit value Mu of the number of the upstream side reception time data 60 that can be stored in the upstream side reception time data queue 41 is defined in advance. In the upstream side reception time data queue 41, if the number of the upstream side reception time data 60 stored in the upstream side reception time data queue 41 exceeds the upper limit value Mu, the packet is discarded in the multicast network 2, and the non-existence of the downstream side reception time data is consequently recognized. In this case, in the upstream side reception time data queue 41, the upstream side reception time data 60 including the upstream side reception time whose time is the oldest is selected and deleted.

As the second method, an updating process for the upstream side reception time data queue 41 is performed for every predetermined time. Here, the updating process implies a process for deleting the upstream side reception time data 60 passing a defined time limit tp. A value of a timeout time to is defined in advance. Then, the time (timeout time) retroactive from a time (current time) tn of the updating by the timeout time to is defined as a time limit tp. For example, when the timeout time to is assumed to be two minutes and the current time is 14:15, the upstream side reception time data queue 41 recognizes that the downstream side reception time data does not exist, because the packet is discarded in the multicast network 2, with respect to the upstream side reception time data 60 including the time prior to 14:13 that is the timeout time. In this case, the upstream side reception time data queue 41 selects and deletes the upstream side reception time data 60 including the time prior to the timeout time.

Here, the timeout time to may be defined as follows. The downstream side reception time data 60 arrives at the downstream side reception time data queue 42 when the packet passes through the multicast network and then the reception time data 60 is generated from the arriving packet in the downstream side measuring unit. In short, if the downstream side reception time data 60 does not arrive even after the elapse of a time period necessary for the foregoing process, the packet is considered to be discarded in the multicast network 2. Thus, it is possible to define the time period during which the packet passes through the multicast network 2, namely, the suitable timeout time by using the time tp required to generate the upstream side reception time data 60 and the transmission delay td. Since the latter time can be assumed to be substantially constant, the time period necessary for the process is measured in advance, and its value may be used. As for the former, a value calculated by the delay measuring section 45 may be used. This value is possibly changed with the time elapse. Thus, the newest measurement result may be used in the delay measuring section each time. A value obtained by adding the time td and the time tp and then further adding a margin time tt in order to give a margin is determined, thereby defining the value as the timeout time to.

It should be noted that the measurement of the distribution quality in the present invention may be performed such that this is started or finished in response to a trigger. For example, the measurement may be started or finished from a predetermined time. Or, the process may be started or finished in response to an instruction through an external interface such as a command line interface or the like. Also, when an instruction of the measurement start is issued to the upstream side measuring apparatus 10 from the downstream side measuring apparatus 20, the upstream side measuring apparatus 10 may start the operation for transmitting the upstream side reception time data 60 to the downstream side measuring apparatus 20.

As explained above, in the measuring system of video image distribution quality according to the first exemplary embodiment of the present invention, the distribution quality can be measured without performing any processing on the packet.

### Second Exemplary Embodiment

In an image distribution quality measuring system according to a second exemplary embodiment of the present invention, the same description as the second exemplary embodiment is omitted. FIG. 16 is a block diagram showing the configuration of the upstream side measuring apparatus 10 and the downstream side measuring apparatus 20. In FIG. 16, the illustration of the unicast network 3 is omitted.

The upstream side measuring apparatus 10 further contains an upstream side hash value generating section 15 as a function block. The hash value generating section 15 is connected to the packet receiving section 11 and the reception time data generating section 12. The downstream side measuring apparatus 20 contains a hash value quality data measuring section 24a instead of the quality data measuring section 24. The downstream side measuring apparatus 20 further contains a downstream side hash value generating section 27 as a function block. The hash value generating section 27 is connected to the packet receiving section 21 and the reception time data generating section 22.

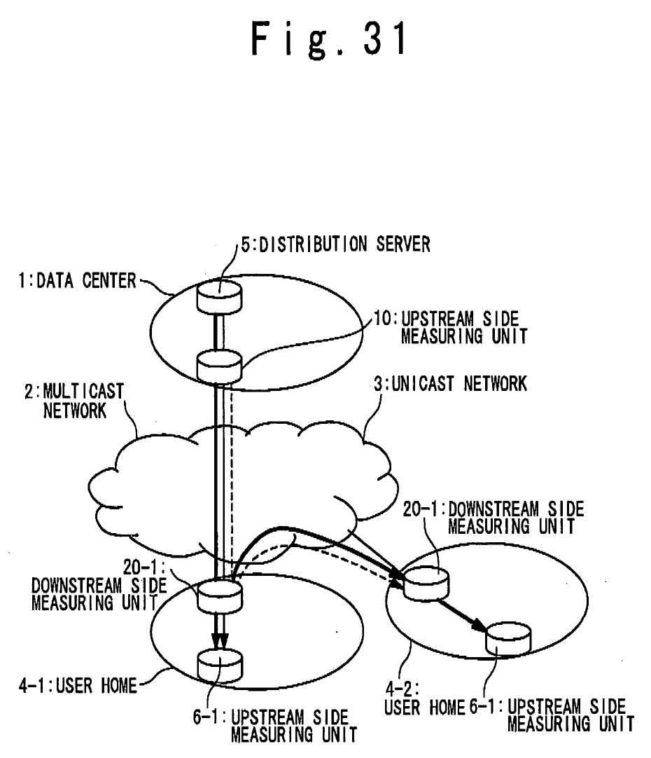

FIG. 17 is a block diagram showing the configuration of the hash value quality data measuring section 24a. The hash value quality data measuring section 24a contains the upstream side reception time data queue 41, the downstream side reception time data queue 42, a hash value comparing section 43a, the packet discard rate measuring section 44, the delay measuring section 45, the jitter measuring section 46, the quality data summing section 47 and the real time clock generating section 48. That is, the hash value quality data measuring section 24a contains the hash value comparing section 43a instead of the reception time data comparing section 43 of the quality data measuring section 24. The hash value comparing section 43a is connected to the upstream side reception time data queue 41, the downstream side reception time data queue 42, the packet discard rate measuring section 44 and the delay measuring section 45. As the point different from the second exemplary embodiment, the upstream side reception time data queue 41 is connected to the packet discard rate measuring section 44.

As the image distribution quality measuring system according to the second exemplary embodiment of the present invention, the operations of the upstream side measuring apparatus 10 and the downstream side measuring apparatus 20 will be described below. Here, only the points different from the description in the first exemplary embodiment will be described.

At first, the operations of the hash value generating sections 15 and 27 will be described. At the steps S1—YES and S11—YES, the hash value generating sections 15 and 27 receive the packets received by the packet receiving sections 11 and 21, respectively, and use a hash function MD5 (RFC1321) to determine a hash value h of the entire packets. The determined hash value h is further sent to the reception time data generating sections 12 and 22. The processes performed by the reception time data generating section 12 and the reception time data generating section 22 at the steps S2 and S12, respectively, will be described below in detail by using FIG. 18.

The reception time data generating section 12 and the reception time data generating section 22 perform steps S73 and S74 instead of the steps S23 and S24. That is, the reception time data generating sections 12 and 22 obtain the hash values h of the packets sent from the hash value generating sections 15 and 27, for the packets sent from the packet receiving sections 11 and 21, respectively (Step S73). The reception time data generating sections 12 and 22 define the current times tc obtained at the step S22, respectively, as the upstream side reception time and the downstream side reception time and generate the reception time data i, which includes the time tc and the hash value h obtained at the step S73 (Step S74). Here, as shown in FIG. 19, the hash value h is stored in the field 63 of the reception time data 60 as the reception time data i.

The process performed by the hash value comparing section 43a of the quality data measuring section 24 in the downstream side measuring apparatus 20 at the step S16 will be described below in detail by using FIG. 20. The hash value comparing section 43a performs steps S83 to S86, instead of the steps S33 to S36 of the steps 531 to S38 that are performed by the reception time data comparing section 43.

The hash value comparing section 43a performs the steps S31 and S32. As a result, the new upstream side reception time data 60 does not exist in the upstream side reception time data queue 41, and the new downstream side reception time data 60 exists in the downstream side reception time data queue 42 (Steps S31—NO, S32—YES). In this case, the hash value comparing section 43a extracts a hash value hd from the downstream side reception time data id as the downstream side reception time data 60 newly stored in the downstream side reception time data queue 42 (Step S83). Next, the hash value comparing section 43a refers to the upstream side reception time data queue 41 and checks whether or not the upstream side reception time data iu including the hash value hd exists as the upstream side reception time data 60 (Step S84). Here, if the reception time data 60 including the same hash value hd does not exist (Step S84—NO), the step S31 is performed.

If the upstream side reception time data 60 is newly stored (Step S31—YES) as the result of the reference of the upstream side reception time data queue 41, the hash value comparing section 43a extracts the hash value hd from the upstream side reception time data iu as its upstream side reception time data 60 (Step S85). Next, the hash value comparing section 43a refers to the downstream side reception time data queue 42 and checks whether or not the downstream side reception time data id including the hash value hd exists (Step S86). Here, if the reception time data 60 including the same hash value hd does not exist (Step S84—NO), the step S31 is performed.

The hash value comparing section 43a checks the existence of the upstream side reception time data iu including the hash value hd, as the result of the reference of the upstream side reception time data queue 41. That is, the hash value comparing section 43a checks the existence of the upstream side reception time data iu including the same hash value as the hash value hd included in the downstream side reception time data id (Step S84—YES). Or, the hash value comparing section 43a refers to the downstream side reception time data queue 42 and checks the existence of the downstream side reception time data id including the hash value hd. That is, the hash value comparing section 43a checks the existence of the downstream side reception time data id including the same hash value as the hash value hd included in the upstream side reception time data iu (Step S86—YES).

In this case, the hash value comparing section 43a takes out the upstream side reception time data iu and the downstream side reception time data id from the upstream side reception time data queue 41 and the downstream side reception time data queue 42, respectively (Step S37). The hash value comparing section 43a uses the upstream side reception time data iu and the downstream side reception time data id as one set and sends to the packet discard rate measuring section 44 and the delay measuring section 45 (Step S38). Then, the step S31 is performed.

As described above, according to the measuring system according to the second exemplary embodiment of the present invention, since the hash value of the packet is used instead of the sequence number, the present invention can be applied irrespectively of the kind of the protocol. For example, the present invention can be applied to a case where the protocol having no sequence number field is treated, a case where the protocol kind is changed depending on a case, or a case where the kind of the use protocol is not known in advance.

It should be noted that the hash value generating sections 15 and 27 in the second exemplary embodiment use the MD5 as the hash function. However, a different hash function having a different hash value length may be used. Typically, as the hash function becomes longer in the hash value, the calculation load becomes higher. However, the possibility that the hash values of the different packets are coincident becomes low.

Also, here, the hash value of the entire packet is calculated. However, the hash value of only the particular part in the packet may be used in order to reduce the calculation load. For example, the calculation of the hash value of only 16 octets from the lead of the packet is allowable.

Also, in case of a protocol having the checksum field, like the UDP header of the packet, the value of the checksum may be used instead of the hash value. Specifically, as shown in FIG. 21, the UDP header 90 has fields 91 and 92 of 32 bits. The field 91 has a field 91a of low order 16 bits and a field 91b of high order 16 bits. The fields 91a and 91b store values indicating a transmission source port number and a destination port number, respectively. The field 92 has a field 92a of 16 lower bits and a field 92b of 16 higher bits. The fields 92a and 92b store the values indicating the UDP packet length and the checksum, respectively. In this case, as shown in FIG. 22, a field 63a of the reception time data 60 stores the value indicating the checksum.

### Third Exemplary Embodiment

In the measuring system according to a third exemplary embodiment of the present invention, the same descriptions as those of the above exemplary embodiments are omitted.

FIG. 23 shows the configuration of the measuring system according to the third exemplary embodiment of the present invention. In the first exemplary embodiment, the upstream side reception time data 60 is transmitted from the upstream side measuring apparatus 10 to the downstream side measuring apparatus 20. On the contrary, the third exemplary embodiment differs from it in that the downstream side reception time data 60 is transmitted from the downstream side measuring apparatus 20 to the upstream side measuring apparatus 10.

FIG. 24 is a block diagram showing the configuration of the upstream side measuring apparatus 10 and the downstream side measuring apparatus 20. In FIG. 24, the illustration of the unicast network 3 is omitted.

The upstream side measuring apparatus 10 contains the packet receiving section 11, the reception time data generating section 12, the real time clock generating section 14, an upstream side reception time data receiving section 16, a quality data measuring section 17 and a quality data recording section 18, as function blocks. That is, the upstream side measuring apparatus 10 contains the reception time data receiving section 16, the quality data measuring section 17 and the quality data recording section 18, instead of the reception time data transmitting section 13 of the upstream side measuring apparatus 10 in the first exemplary embodiment. The reception time data receiving section 16, the quality data measuring section 17 and the quality data recording section 18 serve as the reception time data receiving section 23, the quality data measuring section 24 and the quality data recording section 25 in the downstream side measuring apparatus 20 in the first exemplary embodiment, respectively.

The packet receiving section 11 is connected to the distribution server 5 and the reception time data generating section 12. The reception time data generating section 12 is connected to the real time clock generating section 14 and the quality data measuring section 17. The reception time data receiving section 16 is connected through the unicast network 3 to the downstream side measuring apparatus 20 and connected to the quality data measuring section 17. The quality data measuring section 17 is connected to the quality data recording section 18. The downstream side measuring apparatus 20 contains the packet receiving section 21, the reception time data generating section 22, the real time clock generating section 26 and a downstream side reception time data transmitting section 28, as its function blocks. That is, the downstream side measuring apparatus 20 contains the reception time data transmitting section 28, instead of the reception time data receiving section 23, the quality data measuring section 24 and the quality data recording section 25 in the downstream side measuring apparatus 20 in the first exemplary embodiment. The reception time data transmitting section 28 serves as the reception time data transmitting section 13 in the upstream side measuring apparatus 10 in the first exemplary embodiment.

The packet receiving section 21 is connected to the multicast network 2 and the reception time data generating section 22. The reception time data generating section 22 is connected to the real time clock generating section 26 and the reception time data transmitting section 28. The reception time data transmitting section 28 is connected through the unicast network 3 to the reception time data receiving section 16.

As described above, according to the measuring system based on the third exemplary embodiment of the present invention, the upstream side measuring apparatus 10 can record the distribution quality of the video image. Therefore, the present invention can be used for the purpose of monitoring the distribution quality recorded on the side of the data center 1.

### Forth Exemplary Embodiment

In the measuring system according to a fourth exemplary embodiment of the present invention, the same descriptions as those of the above-mentioned exemplary embodiments are omitted.

FIG. 25 shows the configuration of the measuring system according to the fourth exemplary embodiment of the present invention. The measuring system according to the fourth exemplary embodiment further contains a quality measuring server 30, as compared with the configuration of the measuring system according to the first exemplary embodiment. The quality measuring server 30 is provided in the data center 1. The quality measuring server 30 is connected to the upstream side measuring apparatus 10 inside the data center 1.

In the third exemplary embodiment, the downstream side reception time data 60 is transmitted from the downstream side measuring apparatus 20 to the upstream side measuring apparatus 10. Then, the upstream side measuring apparatus 10 measures the distribution quality of the video image. On the contrary, the fourth exemplary embodiment differs from it in that the quality measuring server 30 is installed in the data center 1, and the upstream side reception time data 60 and the downstream side reception time data 60 are sent from the upstream side measuring apparatus 10 and the downstream side measuring apparatus 20 to this quality measuring server 30, respectively, and the quality measuring server 30 measures the distribution quality.

FIG. 26 is a block diagram showing the configurations of the upstream side measuring apparatus 10, the downstream side measuring apparatus 20 and the quality measuring server 30. In FIG. 26, the illustration of the unicast network 3 is omitted.

The upstream side measuring apparatus 10 has the same configuration as the upstream side measuring apparatus 10 in the first exemplary embodiment. The reception time data transmitting section 13 of the upstream side measuring apparatus 10 differs from the first exemplary embodiment in that this is connected to the quality measuring server 30.

The downstream side measuring apparatus 20 has the same configuration as the downstream side measuring apparatus 20 in the third exemplary embodiment. The reception time data transmitting section 28 of the downstream side measuring apparatus 20 differs from the third exemplary embodiment in that this is connected through the unicast network 3 to the quality measuring server 30.

The quality measuring server 30 contains an upstream side reception time data receiving section 31, a downstream side reception time data receiving section 32, a quality data measuring section 33 and a quality data recording section 34. Each of the sections may be attained in hardware or software. The upstream side reception time data receiving section 31 serves as the reception time data receiving section 23 in the downstream side measuring apparatus 20 in the first exemplary embodiment. The downstream side reception time data receiving section 32 serves as the reception time data receiving section 16 in the upstream side measuring apparatus 10 in the third exemplary embodiment. The quality data measuring section 33 and the quality data recording section 34 serve as the quality data measuring section 24 and the quality data recording section 25 in the downstream side measuring apparatus 20 in the first exemplary embodiment, respectively.

As described above, according to the measuring system according to the fourth exemplary embodiment of the present invention, the video image distribution from the distribution server 5 is performed by using the multicast network. Then, the distribution to the large number of the receiving terminals 6 can be performed at the same time. For this reason, in order to measure the distribution qualities to the large number of the receiving terminals 6, the downstream side measuring apparatuses 20 are required to be provided in front of the respective receiving terminals 6. However, in this case, the load on the upstream side measuring apparatus 10 is heavy under the configuration according to the third exemplary embodiment. The provision of the quality measuring server 30 for measuring the distribution quality as described in the fourth exemplary embodiment can reduce the process load on the upstream side measuring apparatus 10.

It should be noted that since the plurality of distribution measuring servers 30 are provided and the load on the quality measurement is dispersed, which can receive and process the reception time data 60 from the large number of the downstream side measuring apparatuses 20. This case may employ any of a method that one load balancing server representatively receives the reception time data 60 from the downstream side measuring apparatus 20, and it is transferred to the slave server having the lightest load among slave servers; and a method that all servers are flatly arranged and it is received in a round robin. Also, in the downstream side measuring apparatus 20 and the upstream side measuring apparatus 10, an address and port number of the quality measuring server 30 may be made static from the configuration or may be made dynamic through an external interface.

### Fifth Exemplary Embodiment

In the measuring system according to a fifth exemplary embodiment of the present invention, the same description as the above-mentioned exemplary embodiments are omitted.

FIG. 27 shows the configuration of the measuring system according to the fifth exemplary embodiment of the present invention. The measuring system according to the fifth exemplary embodiment further contains a quality managing server 40, as compared with the configuration of the measuring system according to the first exemplary embodiment.

The quality managing server 40 is provided in the data center 1. The quality managing server 40 is connected through the unicast network 3 to the downstream side measuring apparatus 20. In the first exemplary embodiment, the quality data recording section 25 is installed in the downstream side measuring apparatus 20 inside the user home 4. On the contrary, the fifth exemplary embodiment differs from it in that the quality managing server 40 corresponding to the quality data recording section 25 is installed inside the data center 1.

FIG. 28 is a block diagram showing the configurations of the upstream side measuring apparatus 10 and the downstream side measuring apparatus 20. In FIG. 28, the illustration of the unicast network 3 is omitted.

The upstream side measuring apparatus 10 has the same configuration as the upstream side measuring apparatus 10 in the first exemplary embodiment.

The downstream side measuring apparatus 20 contains a quality data transmitting section 25a instead of the quality data recording section 25 in the downstream side measuring apparatus 20 in the first exemplary embodiment, as a function block. The quality data transmitting section 25a is connected to the quality data measuring section 24 and connected through the unicast network 3 to the quality managing server 40 (the quality data recording section 25).

As described above, according to the measuring system based on the fifth exemplary embodiment of the present invention, the distribution quality is recorded in the upstream side measuring apparatus 10 and not in the downstream side measuring apparatus 20.

It should be noted that since a plurality of quality managing servers 40 are provided and the load of the summing of the quality data is dispersed, the distribution quality data from the many downstream side measuring apparatuses can be received and processed. In this case, any of a method that a plurality of slave servers receive the respective distribution quality data and send their summed results to a master server, and a method that the load is dispersed because the downstream side measuring apparatus is registers with a broadcast channel and the address of the quality measuring server 30 which is different for every territory.

Also, in the downstream side measuring apparatus 20, the address and the port number of the quality measuring server 30 may be made static from the configuration or may be made dynamic through the external interface.

### Sixth Exemplary Embodiment

In the measuring system according to a sixth exemplary embodiment of the present invention, the same descriptions as the above-mentioned exemplary embodiments are omitted.

FIG. 29 shows the configuration of an image distribution quality measuring system according to the sixth exemplary embodiment of the present invention. The measuring system according to the sixth exemplary embodiment differs from the configuration of the measuring system according to the first exemplary embodiment in that the upstream side measuring apparatus 10 and the downstream side measuring apparatus 20 are directly provided on each of paths from the distribution server 5 in a multicast tree to the receiving terminals 6.

FIG. 30 is a block diagram showing the configurations of the upstream side measuring apparatus 10 and the downstream side measuring apparatus 20. In FIG. 30, the illustration of the unicast network 3 is omitted. The upstream side measuring apparatus 10 further contains an upstream packet transmitting section 19 as a function block, as compared with the upstream side measuring apparatus 10 in the first exemplary embodiment. The packet transmitting section 19 is connected to the packet receiving section 11 and the multicast network 2. The downstream side measuring apparatus 20 further contains a downstream packet transmitting section 29 as a function block, as compared with the downstream side measuring apparatus 20 in the first exemplary embodiment. The packet transmitting section 29 is connected to the packet receiving section 21 and the receiving terminal 6.

In the sixth exemplary embodiment, since the respective measuring apparatuses 10 and 20 are provided on the path from the distribution server 5 to the receiving terminal 6, the respective measuring apparatuses 10 and 20 are required to transmit the received multicast packets. For this reason, the packet receiving section 11 transmits the received packet to the reception time data generating section 12 and simultaneously transmits to the packet transmitting section 19. The packet transmitting section 19 sends the packet to the multicast network 2. Similarly, in the downstream side measuring apparatus 20, the packet receiving section 21 transmits the received packet to the reception time data generating section 22 as well as the packet transmitting section 29. Then, the packet transmitting section 29 sends the received packet.

As described above, according to the measuring system based on the sixth exemplary embodiment of the present invention, the measurement of a high precision can be attained.

In the first exemplary embodiment, each of the measuring apparatuses 10 and 20 receives the multicast packet branched from the path from the distribution server 5 to the receiving terminal 6 and carries out the measurement. For this reason, the transmission delay and jitter that are generated between the branch from on the path and the arrival at each of the measuring apparatuses 10 and 20 result in the measurement error. On the other hand, in the sixth exemplary embodiment, since the measuring apparatuses 10 and 20 are directly provided on the path, the measurement of the high precision can be attained as compared with the first exemplary embodiment.

Also, through the employment of the configuration based on the sixth exemplary embodiment, the present invention can be applied even if the unicast is used to perform the video image distribution instead of the multicast. In the sixth exemplary embodiment, even if the path from the distribution server 5 to the receiving terminal 6 is the unicast, the measurement can be performed. The foregoing configuration is considered to be assembled into a router and a switch or applied to be a dedicated transferring apparatus and the like.

### Seventh Exemplary Embodiment

In the measuring system according to a seventh exemplary embodiment, the same descriptions as the above-mentioned exemplary embodiments are omitted.

FIG. 31 shows the configuration of the measuring system according to the seventh exemplary embodiment of the present invention. In the measuring system according to the seventh exemplary embodiment, a P2P type configuration is applied to the configuration of the measuring system according to the seventh exemplary embodiment. A video image is transmitted via the unicast network to a certain user home 4 from the distribution server 5 inside the data center 1. At this time, a method that the quality between the upstream side measuring apparatus 10 and the downstream side measuring apparatus 20 is measured has been described in the seventh exemplary embodiment. In a video image distributing system of the P2P type, as user home 4, there are user homes 4-1 and 4-2. The user home 4-1 includes a receiving terminal 6-1 serving as the receiving terminal 6 and a downstream side measuring apparatus 20-1 serving as the downstream side measuring apparatus 20. A user home 4-2 includes a receiving terminal 6-2 serving as the receiving terminal 6 and a downstream side measuring apparatus 20-2 serving as the downstream side measuring apparatus 20. Therefore, the packets are transferred from the receiving terminal 6-1 inside the user home 4-1 through the downstream side measuring apparatuses 20-1 and 20-2 to the receiving terminal 6-2 inside the user home 4-2. For the purpose of the application to this system, the downstream side measuring apparatus 20 is required to have even the function of the upstream side measuring apparatus 10. The measuring apparatus 20-1 inside the user home 4-1 serves as the upstream side measuring apparatus 10 and carries out the measurement between it and the downstream side measuring apparatus 20-2 of the user home 4-2.

As described above, according to the measuring system based on the seventh exemplary embodiment of the present invention, the measuring apparatuses 20-1 and 20-2 provided in the respective user homes 4 have both of the upstream and downstream side measuring functions. Therefore, the present invention can be applied to even the measuring system of the P2P type.

Also, the reception time data 60 may be directly sent from the upstream side measuring apparatus 10 to the downstream side measuring apparatus 20-1. For example, the measuring apparatus is not provided in the user home 4-1. However, when the distribution quality to the user home 4-2 is desired to be measured, such configuration becomes effective.

Also, as described in the fourth exemplary embodiment, the quality measuring server 30 is provided in the data center 1. Therefore, in the quality measuring server 30, the step S18 may be performed on the reception time data 60 from the upstream side measuring apparatus 10 and the respective downstream side measuring apparatuses 20-1 and 20-2.

Also, as described in the fifth exemplary embodiment, the quality measuring server 30 is installed in the data center 1, and the quality measuring server 30 may receive, sum and record the distribution quality data from the respective downstream side measuring apparatuses 20-1 and 20-2.

As mentioned above, according to the present invention, the distribution quality can be measured without performing any processing on the packet.

Although the inventions has been described above in connection with several embodiments thereof, it will be apparent by those skilled in the art that those exemplary embodiments are provided solely for illustrating the present invention, and should not be relied upon to construe the appended claims in a limiting sense.

What is claimed is:

1. A measuring system of distribution quality of a video image, comprising:
a distribution server provided in a center to transmit packets for a video image through a network;
a receiving terminal provided in a user home to receive said packets transmitted through said network from said distribution server;
an upstream side reception time data generating section provided in said center to generate an upstream side reception time data indicating a time when said distribution server transmits one of the packets;
a downstream side reception time data generating section provided for said user home to generate a downstream side reception time data indicating a time when said receiving terminal receives said packet; and
a quality data measuring section provided for one of said center and said user home, to measure a distribution quality indicating a distribution state from said distribution server to said receiving terminal based on said upstream side reception time data and said downstream side reception time data.

2. The measuring system according to claim 1, wherein said upstream side reception time data generating section generates said upstream side reception time data including said upstream side reception time as the time when said distribution server transmits said packet, and a transmission identification data used to identify said packet transmitted from said distribution server, and transmits said upstream side reception time data,
said downstream side reception time data generating section is configured to generate said downstream side reception time data including said downstream side reception time as the time when said receiving terminal receives said packet, and a reception identification data used to identify said packet received by said receiving terminal, and to transmit said downstream side reception time data, and
said quality data measuring section is configured to measure said distribution quality based on said upstream side reception time contained in said upstream side reception time data and said downstream side reception time contained in said downstream side reception time data when said transmission identification data contained in said upstream side reception time data and said reception identification data contained in said downstream side reception time data are coincident with each other.

3. The measuring system according to claim 2, wherein said distribution quality contains a transmission delay, a jitter and a packet discard rate, for every said packet.

4. The measuring system according to claim 3, wherein said quality data measuring section determines said packet discard rate indicating a ratio of a number of said packet which are not received by a downstream side measuring unit to a number of said packets which are received by an upstream side measuring unit for a predetermined time period based on said upstream side reception time contained in said upstream side reception time data and said downstream side reception time contained in said downstream side reception time data.

5. The measuring system according to claim 4, wherein said quality data measuring section determines said transmission delay indicating a time period from said upstream side reception time contained in said upstream side reception time data to said downstream side reception time contained in said downstream side reception time data for said packet.

6. The measuring system according to claim 5, wherein said quality data measuring section determines said jitter indicating a difference between said transmission delay of said packet and said transmission delay of a packet immediately previous to said packet.

7. The measuring system according to claim 1, further comprising:
an upstream side measuring unit provided for said center and comprising said upstream side reception time data generating section; and
a downstream side measuring unit provided for said user home and comprising said downstream side reception time data generating section and said quality data measuring section,
wherein said upstream side measuring unit comprises:
an upstream side packet receiving section configured to receive said packets transmitted from said distribution server to send to said upstream side reception time data generating section; and
an upstream side reception time data transmitting section configured to transmit said upstream side reception time data generated by said upstream side reception time data generating section to said downstream side reception time data generating section through a second network which is different from said first network as said network, and
said downstream side measuring unit comprises:
a downstream side packet receiving section configured to receive said packets which said receiving terminal receives, to send to said downstream side reception time data generating section;
a downstream side reception time data receiving section configured to receive said upstream side reception time data transmitted from said upstream side measuring unit through said second network to transmit to said quality data measuring section; and
a quality data recording section configured to record said distribution quality measured by said quality data measuring section.

8. The measuring system according to claim 1, further comprising:
an upstream side measuring unit provided for said center and comprising said upstream side reception time data generating section and said quality data measuring section; and
a downstream side measuring unit provided for said user home and comprising said downstream side reception time data generating section,
wherein said upstream side measuring unit comprises:
an upstream side packet receiving section configured to receive said packets transmitted from said distribution server to send to said upstream side reception time data generating section; and
an upstream side reception time data receiving section configured to receive said downstream side reception time data transmitted from said downstream side measuring unit through a second network which is different from said first network as said network, to transmit to said quality data measuring section; and
a quality data recording section configured to record said distribution quality measured by said quality data measuring section, and
said downstream side measuring unit comprises:
a downstream side packet receiving section configured to receive said packets received by said receiving terminal, to transmit to said downstream side reception time data generating section; and
a downstream side reception time data transmitting section configured to transmit said downstream side reception time data generated by said downstream side reception time data generating section to said upstream side measuring unit.

9. The measuring system according to claim 1, further comprising:
an upstream side measuring unit provided for said center and comprising said upstream side reception time data generating section;
a downstream side measuring unit provided for said user home and comprising said downstream side reception time data generating section; and
a quality measurement server provided for said center and comprising said quality data measuring section,
wherein said upstream side measuring unit comprises:
said upstream side packet receiving section configured to receive said packets transmitted from said distribution server to transmit to said upstream side reception time data generating section; and
said upstream side reception time data transmitting section configured to transmit said upstream side reception time data generated by said upstream side reception time data generating section to said quality measurement server,
said downstream side measuring unit comprises:
a downstream side packet receiving section configured to receive said packet received by said receiving terminal to transmit to said downstream side reception time data generating section; and
a reception time data transmitting section configured to transmit said downstream side reception time data generated by said downstream side reception time data generating section to said quality measurement server through a second network which is different from said first network said network, and
said quality measurement server comprises:
said upstream side reception time data receiving section configured to receive said upstream side reception time data transmitted from said upstream side measuring unit to transmit to said quality data measuring section;
a downstream side reception time data receiving section configured to receive said downstream side reception time data transmitted through said second network from said downstream side measuring unit to transmit to said quality data measuring section; and
a quality data recording section configured to record said distribution quality measured by said quality data measuring section.

10. The measuring system according to claim 1, further comprising:
an upstream side measuring unit provided for said center and comprising said upstream side reception time data generating section;
a downstream side measuring unit provided for said user home and comprising said downstream side reception time data generating section and said quality data measuring section; and
a quality control server in which said distribution quality is recorded,
wherein said upstream side measuring unit comprises:
an upstream side packet receiving section configured to receive said packet transmitted from said distribution server to transmit to said upstream side reception time data generating section; and
an upstream side reception time data transmitting section configured to transmit said upstream side reception time data generated by said upstream side reception time data generating section to said downstream side measuring unit through a second network which is different from said first network as said network, and
said downstream side measuring unit comprises:
a downstream side packet receiving section configured to receive said packets which said receiving terminal receives, to transmit to said downstream side reception time data generating section;
a downstream side reception time data receiving section configured to receive said upstream side reception time data transmitted through said second network from said upstream side measuring unit to transmit to said quality data measuring section; and
a quality data transmitting section configured to transmit said distribution quality measured by said quality data measuring section to said quality control server through said second network.

11. The measuring system according to claim 7, wherein said distribution server transmits said packets to said upstream side measuring unit,
said upstream side measuring unit further comprises:
an upstream side packet transmitting section configured to transmit said packets received by said upstream side packet receiving section to said network,
said downstream side packet receiving section of said downstream side measuring unit receives said packets transmitted through said network from said upstream side measuring unit, and
said downstream side measuring unit comprises:
a downstream side packet transmitting section configured to transmit said packets received by said downstream side packet receiving section to said receiving terminal.

12. The measuring system according to claim 11, wherein said user home contains said first user home and said second user home,
a first receiving terminal as said receiving terminal and a first downstream side measuring unit as said downstream side measuring unit are provided for said first user home,
a second receiving terminal as said receiving terminal and a second downstream side measuring unit as said downstream side measuring unit are provided for said second user home, and
said packet is transferred to said second receiving terminal from said first receiving terminal through a first and second measuring units downstream side reaches.

13. The measuring system according to claim 2, wherein said transmission identification data and said reception identification data comprise said sequence number contained in each of said packets.

14. The measuring system according to claim 2, wherein said transmission identification data and said reception identification data comprise said hash value of said packet.

15. The measuring system according to claim 2, wherein said quality data measuring section comprises;
an upstream side reception time data queue configured to store said upstream side reception time data in advance;
a downstream side reception time data queue configured to store said downstream side reception time data in advance;
a comparing section configured to compare said upstream side reception time data and said downstream side reception time data when said upstream side reception time data and said downstream side reception time data are stored in said upstream side reception time data queue and said downstream side reception time data queue, respectively; and
a distribution quality measuring section configured to measure said distribution quality based on said upstream side reception time contained in said upstream side reception time data and said downstream side reception time contained in said downstream side reception time data, when said transmission identification data contained in said upstream side reception time data and said downstream side reception identification data contained in said downstream side reception time data are coincident with each other.

16. The measuring system according to claim 15, wherein said upstream side reception time data queue recognizes that said packet is discarded in said network and said downstream side reception time data does not exist since, when a number of said upstream side reception time data stored in said upstream side reception time data queue exceeds a preset upper limit value, and selects and deletes said upstream side reception time data containing the oldest one of said upstream side reception times.

17. The measuring system according to claim 15, wherein said upstream side reception time data queue recognizes that said packet is discarded in said network and said downstream side reception time data does not exist and selects and deletes said upstream side reception time data containing a time before a timeout time from among said upstream side reception time data containing a time before a current time by a preset timeout time.

18. The measuring system according to claim 1, wherein said network is a multicast network.

19. The measuring system according to claim 1, wherein said network is a multicast network, and
said second network is a unicast network.

20. A measuring apparatus used in a distribution quality measuring system comprising a distribution server provided in a center to transmit packets for a video image to a network, and a receiving terminal provided in a user home to receive said packets transmitted through said network from said distribution server, comprising:
an upstream side reception time data generating section provided for said center to generate and transmit an upstream side reception time data indicating a time when said distribution server transmits each of said packets;
a downstream side reception time data generating section provided for said user home to generate and transmit a downstream side reception time data indicating a time when said receiving terminal receives each of said packets; and
a quality data measuring section provided for one of said center and said user home to measure distribution quality of said packets distributed from said distribution server to said receiving terminal based on said upstream side reception time data and said downstream side reception time data.

21. A method of measuring a distribution quality, comprising:
transmitting packets for a video image to a network from a distribution server provided in a center;
receiving said packets transmitted through said network from said distribution server by a receiving terminal provided in a user home;
generating an upstream side reception time data indicating a time when said distribution server transmits each of said packets, by an upstream side reception time data generating section provided for said center;
generating a downstream side reception time data indicating a time when said receiving terminal receives each of said packets, by a downstream side reception time data generating section provided for said user home; and
measuring distribution quality of said packets distributed from said distribution server to said receiving terminal based on said upstream side reception time data and said downstream side reception time data, by a quality data measuring section provided for one of said center and said user home.
